(19) United States
(12) Patent Application Publication
(10) Pub. No.: US 2016/0225029 A1
(43) Pub. Date: Aug. 4, 2016

(54) SYSTEMS AND METHODS FOR A BAR CODE MARKET EXCHANGE FOR ADVERTISING

(71) Applicant: 12 DIGIT MEDIA INC., Menlo Park, CA (US)

(72) Inventor: Scott Raymond VanDeVelde, Menlo Park, CA (US)

(73) Assignee: 12 DIGIT MEDIA INC., Menlo Park, CA (US)

(21) Appl. No.: 15/013,783

(22) Filed: Feb. 2, 2016

Related U.S. Application Data
(60) Provisional application No. 62/111,068, filed on Feb. 2, 2015.

(51) Int. Cl. G06Q 30/02

(52) U.S. Cl. CPC G06Q 30/0268; G06Q 30/0275

(57) ABSTRACT

Campaigns for providing advertisements to a consumer can include collecting shopping cart data from POS terminals in physical stores, the shopping cart data identifying a consumer using a unique consumer identification and identifying one or more UPCs scanned while the identified consumer is present at a POS terminal, and conducting an online UPC auction to collect bids, by UPC(s), for delivery of advertisements to the identified consumer triggered by scanning of a UPC/UPCs, in which winning bids, if any, are determined as of the time the identified consumer is present at the POS terminal. Further, the campaign can include, on behalf of a winning bidder, fulfilling the winning bidder's bid by, at least one of, sending the advertisement to the POS terminal for printing and sending an electronic advertisement to the consumer.

### RELATED APPLICATIONS

This application claims the benefit of U.S. Provisional Patent Application No. 62/111,068 filed on Feb. 2, 2015, which is hereby incorporated by reference.

### BACKGROUND

1. Technological Field

The present technology relates to systems and methods for providing targeted advertisements to an identified consumer. Specifically, the present technology relates to systems and methods for targeting consumer interests in a product and delivering targeted advertising based on the consumer's interest in the product and based on received bids from one or more entities for providing the targeted advertising to the identified consumer.

2. Description of Related Art

Advertisements and offers, which are promotional materials that entice a consumer to try a new product and/or increase their use of a product, have been used since the early 1700s and coupons, which often times accompany advertisements are vouchers entitling the holder to a discount for a particular product, have been used as marketing tools since Coca Cola issued the first coupon in 1887. Since then, the use of advertisements and offers has skyrocketed. For example, paper coupons, which are a sub-category of advertisements, have grown into a $4 billion market in the U.S. alone, with a current redemption rate of approximately 3 billion coupons a year. However, the high point for paper coupons was in 1992, when 7.9 billion discounts were redeemed. Market research indicates that consumer expectations are moving away from paper advertisements and offers and toward advertisements and offers in electronic format.

In 1973, after 4 years of preparation, IBM presented a proposal to the Super Market Committee in Rochester, Minn. for a bar code format and associated scanner to improve supply chain management. The goal was to develop a system that would uniquely identify each product from each manufacturer. The system was called a Universal Product Code (UPC), and it was accepted by the Super Market Committee. This decision ultimately led to the creation of the international standards organization called GS1, formerly known as the Uniform Code Council, which now assists 110 member countries with supply chain standards. The UPC code defined 10 different numbering systems, where 5 of the 10 numbering systems were for most products, 1 of the 10 numbering systems was for local use for products sold by weight, 1 of the 10 numbering systems was for drugs based on the National Drug Code, 1 of the 10 numbering systems was for local use for loyalty cards or store coupons, and 2 of the 10 numbering systems were for manufacturer coupons. The UPC is considered a foundational, one dimensional coding system, with extensions such as UPN (i.e., universal product numbers, typically for providing codes for identifying pharmaceutical products, medical devices, etc.), UPC-E, which is a variation of the standard UPC that excludes any zeros, EAN (i.e., a European article number), ISBN (i.e., an international standard book number), and so on. Throughout this document, the term UPC is generally used and may include additional codes, such as those mentioned above or those mentioned below.

Additional two dimensional coding systems such as PDF417, GS1 Databar, DataMatrix, and QR Code can store much more data in a smaller area, and are useful additions to the UPC method. In this application, reference to a UPC code is, in the interest of brevity, inclusive of all point of sale product coding systems, and does not limit in any way the coding systems available to the technology disclosed.

A manufacturer of a product can use advertisements in a number of ways. For example, an advertisement can be geared to get a consumer interested in purchasing a given product, or to get them to visit a store on certain days at certain times or to get a consumer to go to a manufacturer's web-site to learn more about a product. The manufacturer can direct advertisements toward their current consumers (e.g., customers) in order to increase overall visibility and sales of a particular item. Or, the manufacturer can distribute advertisements with a goal to convert the competitor's customer into the manufacturer's customer.

### General Shortcomings of the Related Art

The use of advertisements not only help a manufacturer promote their own product, but can be a marketing tool used to target specific competitors. In one example, the Cheerios® brand from General Mills® ideally might want to advertise a new Cheerios® breakfast bar to their consumers who recently purchased a 16 oz. Cheerios® brand. And Kellogg's®, a competitor, might ideally want to distribute an advertisement for their 16 oz. box of Corn Flakes® in an attempt to gain a trial. But without having the knowledge and ability to identify and distribute highly personalized and targeted advertisements a common method is for each of the manufacturers to distribute a large number of “generically targeted” advertisements based on demographics or segments (e.g., soccer moms). An average price for these advertisements (delivered digitally) can be $4.50 to $10 per 1,000 advertisements, which is often referred to as a cost per mille (CPM).

Generally, manufacturers do not have access to retailer's data regarding transactions with consumers. Without direct access to the retailer's data, it is difficult for manufacturers to promote, and distribute personalized and relevant advertisements to consumers with scale based on their purchase habits on products and categories they buy. As a result manufacturers just target advertisements to demographic segments and put out bulk amounts of untargeted advertisements in broad reach vehicles (e.g., television, digitally on numerous websites, print, etc.).

These general shortcomings of the related art are address by the technology disclosed.

### Specific Manufacturer Challenges and Solutions Provided by the Technology Disclosed

Despite all the technical and digital advancements over the past 20 years, manufacturers continue to use the outdated asynchronous method of trying to engage with consumers. As a result there continues to be a proliferation of generic advertisements that add little value to retailers, consumers and manufacturers. The issues for manufacturers include: (i) reach; (ii) volume; (iii) efficiency; (iv) thin margins; (v) lack of real-time data and analysis; and (vi) difficulty in targeting a long tail of consumer product interest.

Regarding the manufacturer's thin margins, for many CPG manufacturers lack of targeting makes it an unwise financial investment for creating and distributing these mass (non-targeted) advertisements. For example, with fixed pricing for distribution, it is a money losing proposition to frequently deliver advertisements to consumers via traditional means.

Regarding manufacturer's lack of real time data and analysis, due to long lead prior to delivery, manufacturers are unable to quickly measure return on investment (ROI) and apply many of the real-time test and learn methodologies that are afforded by many internet models (e.g., search engine marketing such as Google Adwords®).

Regarding manufacturer's difficulty in targeting consumer's interests, there are over 35,000 products sold in grocery stores, and manufacturers have little visibility into the purchasing behavior of individual consumers (“Guess How Many Items the Average Grocery Shopper Buys in a Year?” Jan. 23, 2013, http://couponsinthenews.com/2014/01/23/guess-how-many-items-the-average-grocery-shopper-buys-in-a-year/). As such they target their advertisement buys at “demographic segments” versus having the ability to target specifically at the individual consumer level.

The technology disclosed responds to these technical challenges by providing some or all of the following advantages over current advertisements distribution methods. For example, the technology disclosed may provide advertisement distribution methods that are targeted at the UPC level (e.g., a UPC granular level), that provide dashboards for analysis and that provide A/B (e.g., split) and multivariate testing (e.g., auditioning) of advertisements to measure the results of their marketing efforts.

### Additional Manufacturer, Retailer and Consumer Challenges and Solutions Provided by the Technology Disclosed

In the traditional manufacturer/retailer/advertisement environment, there is a contemplation of “scarcity” meaning that there will be a limited number of advertisements distributed to consumers by category so only the top winning manufacturer bids will get fulfilled, and that there will be a limited number of advertisement impressions (e.g., advertisements that can be delivered) available per consumer at any given point in time. There is also contemplation of “guaranteed distribution” by a manufacturer willing to pay a premium and for pre-book impression distribution before the bidding process begins. In this traditional environment, there are challenges involving each of manufacturer, retailer and consumer. Many of these challenges and potential solutions thereto by the technology disclosed are discussed below.

Another challenge is that current advertisement distribution methods are only cost effective for the largest manufacturers, such that the current distribution methods are not viable for smaller manufacturers. The technology disclosed is capable of overcoming these challenges by providing performance based bidding options for the manufacturers and providing an aggregation of niche audiences through granular UPC data.

Another challenge is that current advertisement targeting solutions may lock out certain manufacturers/advertisers by selling advertisements on a category exclusive basis using, for example, a pre-auction channel. The technology disclosed is capable of overcoming this challenge by providing an open, real-time marketplace available to all UPCs and/or available to remnant UPCs that have not been exclusively sold through a pre-auction channel.

Another challenge is that there are hundreds of thousands of UPCs making it cumbersome to create a campaign for each individual UPC target. The technology disclosed is capable of overcoming these challenges by providing a searchable database for the manufacturers to target advertisements, by providing campaign wizards and templates to the manufacturers, by providing a programmatic interface, such as customizable bidding interfaces and customizable campaign results interfaces, and by providing for the automatic addition of new UPCs to the database.

Another challenge is that the cost of effectively targeting a long tail of consumer UPC/product interest and delivering a hyper-targeted advertisement to a large targeted consumer population on a timely basis relative to their interests. The technology disclosed is capable of overcoming these challenges by allowing manufacturers to view hundreds of thousands of products in a searchable database, each identified by their unique UPC, that are being purchased by their customers and/or competitors customers, by allowing manufactures to cherry pick and select only a collection of UPCs that represent their target audience (e.g., consumers who buy their own product UPCs or the buyers of competitive products) and competitively bid for the ability to have their specific product advertisement delivered to this audience, by allowing manufacturers that are in low penetration categories (e.g., baby food at 15% population) to avoid spending impressions/budget against the remaining 85% of the population who doesn't buy this category and instead put that budget against advertisements for the 15% category buyers, by providing feedback to the manufacturer if the manufacturer's bids are too low, such as for example, providing suggested bids, reminders and estimated inventory, and by providing the manufacturers with a wizard that enables suggested campaigns (e.g., groups of UPCs to target, number of impressions per user, etc.) based on inputs such as campaign objectives, budgets and metrics for success.

### Additional Retailer Challenges and Solutions Provided by the Technology Disclosed

While retailers have millions of consumers who walk through their aisles each week they do not use technology to either improve the consumer experience in their stores or to monetize this traffic in ways other than the small margins made on grocery items. Additionally they are at the mercy of manufacturer programs that haven't changed much in 20 years. As a result they face the following challenges: (i) low margins; and (ii) little monetization of store traffic.

Regarding the challenge of low margins for the retailers, retailers make very little money selling groceries and much of the money they do make comes from trade dollars or market development funds (MDF) paid for by manufacturers which has nothing to do with the actual selling of products but instead is money paid to the retailer to shelve and feature certain products at certain locations throughout the year (e.g., slotting fees, end cap displays, features in store circular, loyalty programs, etc.).

Regarding the challenge of little monetization of store traffic, retailers attract millions of consumers into their stores each week with the average consumer going into a grocery store more than twice a week (“U.S. Grocery Shopper Trends 2012 Executive Summary,” http://www.icn-net.com/docs/12086_FMIN_Trends2012_v5.pdf). However, non-targeted advertisements often times do not provide any sales lift for the retailer. As a result, the retailer is not making any additional profit, despite the millions of consumers in their stores each week.

These above-described problems can be solved using the technology disclosed which provides a programmatic marketplace, where the retailer can achieve better monetization of regional consumer purchase data, where the retailer can utilize a self-service marketplace individually or within a group of retailers to achieve a national footprint (e.g., through an establishment of a consortium of retailers) for vendors to target with national marketing dollars, and where the retailer and vendor can develop a more cost effective way to work with the long tail of vendors (e.g., of 10,000 plus brand manufacturers as they develop merchandising plans together). Realistically it is not feasible to spend a lot of time with each manufacturer to create promotional advertisement campaigns on a regular basis, but this problem is solved by the technology disclosed which can provide a self-service marketplace where vendors can routinely log in and create their own campaigns in minutes.

### Additional Consumer Challenges and Solutions Provided by the Technology Disclosed

Consumers have embraced all the internet platforms and services that have profoundly improved their lives and personalized their shopping experience online and that have saved them time and/or money. Unfortunately these advances haven't progressed to the grocery store making consumers feel that they are not benefiting from the new technology provided on, for example, the internet platform, and making consumers feel that there is no level of personalized and/or customized advertisements.

The technology disclosed solves these consumer problems by providing a marketplace (e.g., an online exchange, an online auction, etc.) for implementing campaigns using relevance algorithms based on, for example: (i) bid rate/amount (e.g., highest bid for delivery of an advertisement); (ii) propensity to purchase a particular UPC at the consumer level; and (iii) beacon prompting so when a consumer is in a given section/aisle they are prompted with an advertisement that is appropriate for them.

Another challenge for the consumer is that many of the brands/items that consumers shop for don't have advertisements available. Advertisements are typically limited to large, national brands, not smaller or more regional brands, leaving, for example, a large amount of remnant UPCs and/or non-remnant UPCs that could be targeted for an advertisement campaign. To address these challenges the technology disclosed can provide an open, real-time marketplace and provide an aggregation of advertisements to niche audiences through granular level and/or group level UPC data.

These challenges are addressed by the technology disclosed, which can provide a programmatic marketplace in which collaborative filtering can be used to learn success rates of the advertisements delivered to a similar target audience to ensure consumer relevancy, and can provide marketplace intelligence that powers a consumer (e.g., mobile device) application to deliver a large quantity of digital advertisements that are categorized and sorted based on the consumers' demonstrated historical purchases.

Additional benefits of the technology disclosed are that it will be possible to: (i) achieve true customization at the user level, such that, for example, even with tens of millions of consumers, two consumers will most likely not get the same portfolio of advertisements; (ii) maintain a better understanding on how to optimize an order of advertisements presented to the consumer, such as in an application running on a portable consumer device, by placing most relevant advertisements in a prominent position for each consumer based on the consumer's propensity to make a purchase in that category; (iii) provide the consumer with the ability to search/rank advertisements based on numerous filter criteria (e.g., product category, etc.); (iv) provide the consumer with the ability to rank/remove each advertisement (e.g. keep each advertisement in the application running on the portable consumer device, remove each advertisement as a corresponding product is purchased and/or, remove each advertisement and never show it again, even if the a purchase has not been made that is related to that advertisement); (v) provide the consumer with the ability to create and print shopping lists while easily incorporating items for which advertisements have been provided into the shopping list; (vi) automatically remove advertisements after a certain expiration date; (vii) provide the manufacturer the ability to modify expiration dates of advertisements based on new winning bids; (viii) easily deliver advertisements to the consumer directly (e.g., in a printed version at the time of purchase at a POS terminal) or via the application running on the consumer's portable device at or around (e.g., within a few hours; within 24 hours, etc.) the time of purchase based on UPCs (e.g., the intent would be that the advertisements are delivered to the consumer prior to their next visit to the retailer); (ix) control a frequency of providing advertisements at the user level based on manufacturers' and retailers' unique knowledge of consumer purchasing habits and providing an ability to identify consumers based on their application running on the consumer's portable device; and (x) provide numerous ways for the application running on the consumer's portable device to interface with communication points (e.g., store beacons) within the retailer's facility for providing intelligent consumer alerts and advertisements.

In summary, the state of the related art is such that a bulk of advertisements are designed to grab the attention of a consumer for a particular UPC for a campaign that is not targeted at a UPC granular level and with a duration of, usually, months at a time, where each part of the advertisement distribution process requires a substantial time frame, and where FSI advertisements typically require nine to twelve weeks for art and distribution. The technology disclosed allows the procurement and distribution of advertisements in near real time targeted at a UPC granular level as briefly discussed above and as described in detail below.

### SUMMARY OF THE INVENTION

Aspects of the present disclosure are to address at least the above-mentioned problems and/or disadvantages and to provide at least the advantages discussed above and further described below. Accordingly, an aspect of the present disclosure is to provide a computer-implemented method and a system for targeting consumer interest in a product and delivering targeted advertisements based on the consumer's interests in the product.

In accordance with an aspect of the present disclosure a computer-implemented method of providing one or more targeted advertisements to a consumer is provided. The computer-implemented method includes collecting shopping cart data from numerous point of sale (POS) terminals in physical stores, the shopping cart data identifying a consumer using a unique consumer identification and identifying one or more universal product codes (UPCs) scanned while the identified consumer is present at one of the POS terminals, and conducting an online UPC auction to collect bids, by UPC or a group of UPCs, for delivery of advertisements to the identified consumer triggered by scanning of a UPC or UPCs in the physical stores, in which winning bids, if any, are determined as of the time the identified consumer is present at the POS terminal

In this computer-implemented method a current winning bidder for a particular UPC is entitled to send their advertisement to the POS terminal for printing and/or send an electronic advertisement to the identified consumer, and the online UPC auction accepts bids and withdrawal of bids from bidding participants using bidding terminals, and determines the current winning bidder from among the bidding participants on an ongoing basis by (i) providing a bidding interface to the bidding terminals that identifies the UPCs that are available through the online UPC auction, (ii) receiving from the bidding interface, bids on selected UPCs of the available UPCs, (iii) tracking, for the selected UPCs, bid scores based at least in part on the bids on the selected UPCs, and (iv) while the identified consumer remains present at the POS terminal, using at least the bid scores to determine a current best bid for a particular UPC and determining, among the one or more UPCs identified by the shopping cart data, which UPCs have winning bidders.

Finally, this computer-implemented method includes, on behalf of a winning bidder, fulfilling the winning bidder's bid by, at least one of, sending the advertisement to the POS terminal for printing and sending the electronic advertisement to the identified consumer

In accordance with another aspect of the present disclosure a computer-implemented method of providing one or more targeted advertisements to a consumer is provided. This computer-implemented method includes collecting one or more UPCs scanned while a consumer is present at one POS terminal of numerous POS terminals in physical stores, and conducting an online UPC auction to collect bids, by UPC or a group of UPCs, for delivery of advertisements to the consumer triggered by scanning of a UPC or UPCs in the physical stores, in which winning bids, if any, are determined as of the time the consumer is present at the POS terminal.

In this computer-implemented method a current winning bidder for a particular UPC is entitled to send their advertisement to the POS terminal for printing, and the online UPC auction accepts bids and withdrawal of bids from bidding participants using bidding terminals, and determines the current winning bidder from among the bidding participants on an ongoing basis by (i) providing a bidding interface to the bidding terminals that identifies the UPCs that are available through the online UPC auction, (ii) receiving from the bidding interface, bids on selected UPCs of the available UPCs, (iii) tracking, for the selected UPCs, bid scores based at least in part on the bids on the selected UPCs, and (iv) while the consumer remains present at the POS terminal, using at least the bid scores to determine a current best bid for a particular UPC and determining, among the one or more collected UPCs, which UPCs have winning bidders.

Finally, this computer-implemented method includes, on behalf of a winning bidder, fulfilling the winning bidder's bid by sending the advertisement to the POS terminal for printing.

In accordance with another aspect of the present disclosure a computer-implemented method of providing one or more targeted advertisements to a consumer is provided. This computer-implemented method includes accumulating, as historical data, shopping cart data from numerous POS terminals in physical stores, the shopping cart data identifying a consumer using a unique consumer identification and identifying one or more UPCs scanned while the identified consumer is present at one of the POS terminals, and conducting an online UPC auction to collect bids, by UPC or a group of UPCs, for delivery of advertisements to the identified consumer triggered by identification of the consumer at the POS terminal, in combination with the historical data that identifies UPCs of goods purchased by the identified consumer in the physical stores, in which winning bids, if any, are determined as of the time the identified consumer is present at the POS terminal.

In this computer-implemented method the online UPC auction is conducted using the one or more UPCs identified by the historical data collected in a historical period of at least one week and associated with the unique consumer identification of the identified consumer, a current winning bidder for a particular UPC is entitled to send their advertisement to the POS terminal for printing and/or send an electronic advertisement to the identified consumer, and the online UPC auction accepts bids and withdrawal of bids from bidding participants using bidding terminals, and determines the current winning bidder from among the bidding participants on an ongoing basis by (i) receiving from a bidding interface, bids on selected UPCs of UPCs that are available UPCs through the online UPC auction, the selected UPCs being included in the historical data, (ii) tracking, for the selected UPCs, bid scores based at least in part on the bids on the selected UPCs, and (iii) while the identified consumer remains present at the POS terminal, using at least the bid scores to determine a current best bid for a particular UPC and determining, among the one or more UPCs identified by the historical data, which UPCs have winning bidders.

Finally, this computer-implemented method includes, on behalf of a winning bidder, fulfilling the winning bidder's bid by, at least one of, sending the advertisement to the POS terminal for printing and sending the electronic advertisement to the identified consumer.

In accordance with another aspect of the present disclosure a computer-implemented method of providing one or more targeted advertisements to a consumer is provided. This computer-implemented method includes collecting shopping cart data from numerous POS terminals in physical stores, the shopping cart data identifying a consumer using a unique consumer identification and identifying one or more remnant UPCs scanned while the identified consumer is present at one of the POS terminals, and conducting an online UPC auction to collect bids, by UPC or a group of UPCs, for delivery of advertisements to the identified consumer triggered by scanning of a remnant UPC or remnant UPCs in the physical stores, in which winning bids, if any, are determined as of the time the identified consumer is present at the POS terminal.

In this computer-implemented method the remnant UPC or the remnant UPCs are a portion of available UPCs that have not been exclusively sold through a pre-auction channel, a current winning bidder for a particular remnant UPC is entitled to send their advertisement to the POS terminal for printing and/or send an electronic advertisement to the identified consumer, and the online UPC auction accepts bids and withdrawal of bids from bidding participants using bidding terminals, and determines the current winning bidder from among the bidding participants on an ongoing basis by (i) providing a bidding interface to the bidding terminals that identifies the remnant UPCs that are available through the online UPC auction, (ii) receiving from the bidding interface, bids on selected remnant UPCs of the available remnant UPCs, (iii) tracking, for the selected remnant UPCs, bid scores based at least in part on the bids on the selected remnant UPCs, and (iv) while the identified consumer remains present at the POS terminal, using at least the bid scores to determine a current best bid for a particular remnant UPC and determining, among the one or more remnant UPCs identified by the shopping cart data, which remnant UPCs have winning bidders.

Finally, this computer-implemented method includes, on behalf of a winning bidder, fulfilling the winning bidder's bid by, at least one of, sending the advertisement to the POS terminal for printing and sending the electronic advertisement to the identified consumer.

In accordance with another aspect of the present disclosure a system for providing one or more targeted advertisements to a consumer is provided. The system includes a bidding server including a processor and memory configured to receive shopping cart data collected from numerous POS terminals in physical stores, the shopping cart data identifying a consumer using a unique consumer identification and identifying one or more universal product codes UPCs scanned while the identified consumer is present at one of the POS terminals, and conduct an online UPC auction to collect bids, by UPC or a group of UPCs, for delivery of advertisements to the identified consumer triggered by scanning of a UPC or UPCs in the physical stores, in which winning bids, if any, are determined as of the time the identified consumer is present at the POS terminal, wherein (i) a current winning bidder for a particular UPC is entitled to, via a fulfillment server, send their advertisement to the POS terminal for printing and/or send an electronic advertisement to the identified consumer, and (ii) the bidding server, by conducting the online UPC auction, accepts bids and withdrawal of bids from bidding participants using bidding terminals, and determines the current winning bidder from among the bidding participants on an ongoing basis by providing a bidding interface to the bidding terminals that identifies the UPCs that are available through the online UPC auction, receiving from the bidding interface, bids on selected UPCs of the available UPCs, tracking, for the selected UPCs, bid scores based at least in part on the bids on the selected UPCs, and while the identified consumer remains present at the POS terminal, using at least the bid scores to determine a current best bid for a particular UPC and determining, among the one or more UPCs identified by the shopping cart data, which UPCs have winning bidders.

Further, this system includes the fulfillment server including a processor and a memory configured to, on behalf of a winning bidder determined by the bidding server, fulfilling the winning bidder's bid by, at least one of, sending the advertisement to the POS terminal for printing and sending the electronic advertisement to the identified consumer.

The various above-described operations of the method are not necessarily limited to the order in which they are described. The order listed above is merely for ease of readability and understanding. Accordingly, the order listed above has no bearing on the actual order of operations performed by the method.

Other aspects, advantages, and salient features of the disclosure will become apparent to those skilled in the art from the following detailed description, which, taken in conjunction with the drawings, discloses various embodiments of the present disclosure.

### BRIEF DESCRIPTION OF THE DRAWINGS

FIG. 1 illustrates an overview of an implementation of an infrastructure servicing a manufacturer, a retailer, and a consumer, according to an embodiment of the present disclosure.

FIG. 2 illustrates one implementation of a process cycle for a consumer, according to an embodiment of the present disclosure.

FIG. 3 illustrates one implementation of UPC targeting process by a manufacturer, according to an embodiment of the present disclosure.

FIG. 4 illustrates one implementation of an advertisement delivery process by a retailer, according to an embodiment of the present disclosure.

FIG. 5 illustrates a process of adding advertisements to a consumer's account, according to an embodiment of the present disclosure.

FIG. 6 illustrates one implementation of a process for a consumer receiving advertisements on a consumer application, according to an embodiment of the present disclosure.

FIG. 7 illustrates one implementation of a process for a retailer to identify a batch of advertisements represented by a QR code, according to an embodiment of the present disclosure.

FIG. 8 illustrates one implementation of A/B test configuration, according to an embodiment of the present disclosure.

FIGS. 9A, 9B, 9C and 9D illustrate various implementations of providing one or more targeted advertisements to a consumer, according to various embodiments of the present disclosure.

FIG. 10 illustrates an implementation of a login screen of an online exchange, according to an embodiment of the present disclosure.

FIG. 11 illustrates an implementation of a campaign wizard of an online exchange for selecting a partner and choosing a campaign objective of a specific campaign, according to an embodiment of the present disclosure.

FIG. 12 illustrates an implementation of a campaign wizard of an online exchange for defining an audience of a specific campaign, according to an embodiment of the present disclosure.

FIG. 13 illustrates an implementation of a campaign wizard of an online exchange for defining audience loyalty and selecting a type of advertisement to be provided for a specific campaign, according to an embodiment of the present disclosure, according to an embodiment of the present disclosure.

FIG. 14 illustrates an implementation of a campaign wizard of an online exchange for setting a budget and timeframe for a specific campaign, according to an embodiment of the present disclosure.

FIG. 15 illustrates a dashboard of an online exchange that provides real-time analytics for a specific campaign, according to an embodiment of the present disclosure.

FIG. 16 illustrates an interface of an online exchange that provides real-time monitoring and adjustment of a specific campaign, according to an embodiment of the present disclosure.

FIG. 17 illustrates an interface of an online exchange that provides real-time information regarding a lift of sales for a retailer, according to an embodiment of the present disclosure.

FIG. 18 illustrates screenshots of a consumer application implemented on a smart phone, according to an embodiment of the present disclosure.

FIGS. 19A, 19B, 19C and 19D illustrate a data structures, according to various embodiments of the present disclosure.

FIG. 20 illustrates a block diagram of an example computer system, according to an embodiment of the present disclosure.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

In general, the technology disclosed is directed to a product (e.g., UPC) marketplace (e.g., an online exchange, online auction, etc.). More specifically, the marketplace allows a manufacturer to bid on a specific product UPC and thereby obtain an entitlement to provide an advertisement to a consumer that is considering purchasing a product related to that UPC or to a consumer who has purchased that given UPC product. The term manufacturer may be, in certain contexts, synonymous with the terms provider, seller, user, marketer, bid manager (BM), etc. As such, throughout the present document, the above-described terms are to be interchangeable in certain contexts.

There are many ‘bidding components’ that will be considered for a successful bid such as price paid by a manufacturer and potential relevancy of the advertisement. Bidding can be conducted programmatically. Manufacturers monitor results through a dashboard and can react quickly to market conditions. For example, in an implementation the manufacturer may be provided with an option to elect (e.g., the manufacturer is provided with an election) whether or not to deliver an advertisement to a consumer if the manufacturer has won a bid that enables the manufacturer to send an advertisement (or have an advertisement sent) to the consumer. In another implementation, the manufacturer, once provided with an election after winning the bid, may determine other aspects of the advertisement based on various criteria related to the consumer. The manufacturer can implement a defensive marketing strategy by electing to not send an advertisement to the consumer. This can be achieved, by example, providing the election results to the winning bidder (e.g., manufacturer) and allowing the winning bidder (e.g., manufacturer) to make an election as to which action to take next (e.g., not send any advertisement, or send a specific type of advertisement, etc.). Consumers can see advertisement across personal computing devices, mobile devices, etc. and can access/view advertisements using, for example, a proprietary “12 Digit Media” consumer application or an application provided by a retailer (e.g., grocery retailer), but advertisements can also be delivered by other means (e.g. email, printed delivery at a POS). The term retailer may be, in certain contexts, synonymous with the terms seller, physical store, user, retail outlet, etc. As such, throughout the present document, the above-described terms are to be interchangeable in certain contexts. The term consumer may be, in certain contexts, synonymous with the terms buyer, customer, purchaser, user, etc. As such, throughout the present document, the above-described items are to be interchangeable in certain contexts. Benefits of this above-described structure include financial incentives to the retailer, precision targeting of consumers by manufacturers at a granular UPC level and based on, for example, remnant UPCs, and more timely and relevant advertisement to consumer.

In order to address the above-described issue of providing non-targeted promotional campaigns that are wasteful in terms of expense, effort and time, the technology disclosed provides systems and methods for targeting advertisement. For example, if General Mills knew who the consumers of Cheerios® (a General Mills® product) were and knew who competitor (e.g., Froot Loops®, from Kellogg's®) cereal buyers were, General Mills® could distribute an advertisement directly to a targeted consumer and avoid printing and distributing millions of advertisements nationwide to consumers who do not purchase in this cereal category. Likewise, if Kellogg's® wanted to have its advertisement delivered directly to the General Mills® consumer/purchaser to attempt to convert the consumer to a Kellogg's® consumer/purchaser, better targeting methods should be utilized.

In one example, the actions of the consumer, such as the purchase of a cereal at a retail outlet, can trigger the printing of an advertisement at the POS. This is a highly valued source of information, and can receive a higher CPM as opposed to non-targeted advertisements. In this example, there is an opportunity for a market to sell the rights to distribute advertisements upon the purchase trigger.

Specifically, the technology disclosed provides a marketplace (e.g., online exchange) that allows General Mills® to bid for the right/entitlement to distribute an advertisement to someone who buys a product with a scanned UPC number (e.g., a UPC-A, which is the most common version of UPCs) of 0 16000 27526 3, which is the 8.9 oz. box of Cheerios®. As well, Kellogg's® can also bid for the right to distribute their advertisement for Corn Flakes® to the consumer who just purchased the 8.9 oz. box of Cheerios®. The technology disclosed not only allows for this form of distribution of electronic advertisements, but can support the distribution of advertisements as the consumer browses the retail store shelves. Many different types of advertisements can be provided to the consumer, such as display or product videos that accompany, for example, a basic electronic advertisement, which can increase the likelihood of the consumer purchasing a related product, which will also increase the potential value of the advertisement to the retailer and the manufacturer.

Furthermore, in order to address the above-described issue of manufacturers not having access to retailer's data regarding transactions with consumers, the technology disclosed provides a marketplace whereby manufacturers can identify categories and products (by UPC or some other barcode such as EAN, ISBN) that consumers will be considering and/or purchasing in a future period, and bid to win the right to deliver an advertisement to that consumer related to the product barcode.

Specifically, the technology discloses is a system and method for enabling manufacturers using a computer network such as the Internet to enable them to: (i) develop sophisticated promotional advertisement campaigns at the consumer level (e.g., UPC granular level) based on the scan of a barcode through a POS system; (ii) bid and pay based on, for example, each placement/delivery of advertisements to these consumers; (iii) deliver to the consumer via an online means (e.g., digital advertisements) and/or offline (e.g. printed advertisements and direct mail); (iv) get detailed manufacturer analysis and deep insights into purchase behavior vs. advertisement delivery at the UPC level; and (v) get detailed retailer analysis and deep insights into manufacturer spending and category growth metrics.

The system and method of the present technology disclosed provides a database having brands for each manufacturer (e.g., provider, deliverer, etc.) of products/goods. The manufacturer influences distribution of their advertisement to a consumer through a continuous (e.g., ongoing) online competitive bidding process, or through an online bidding process that ends at a specific time (e.g., the bidding process may end after a day, week, month, etc. from commencement). The bidding process occurs when the manufacturer transacts in the marketplace by entering “bidding” components for a given UPC listing (at the UPC granular level) or for a collective grouping of numerous UPCs (still can be at a UPC granular level) in a given category/subcategory. For example, the collective grouping of UPCs can be directed to a specific group of UPCs that are related to a single specific UPC or another group of UPCs. Each brand of the manufacturer may have contact and billing information for the manufacturer and each of the manufacturer's brand UPCs associated therewith. When the manufacturer enters the marketplace (e.g., an online exchange, an online auction, etc.) and wants to bid on a given UPC or set of UPCs, they submit numerous “bidding components.” These components will enable algorithms to be implemented by the marketplace to pick winning bids and/or a winning bidder. As discussed in more detail below, the winning bids and/or winning bidder may be chosen simply based on the highest bid or may be chosen using factors other than only the bid amount (e.g., relevancy of bid, etc.). As such, the bidder with the highest bid may not always be the winning bidder, because of the above-described factors that can be taken into consideration when determining the winning bidder.

Specifically, in an implementation, the marketplace can provide the following: the specific UPCs of all the products that the manufacturer wants to trigger an advertisement on; a dollar amount based advertisement unit to be provided to the consumer; determination of how many products need to be purchased to receive an advertisement; creative components of the advertisement; a desired quantity of impressions (e.g., advertisements delivered) to be purchased/budgeted; and a bid amount range (e.g., a starting price, a maximum bid, etc.). The system and method of the present technology disclosed then enables scoring of every manufacturer bid request and compares all bid amounts for the same UPC or UPCs and terms associated therewith, along with additional data that can be useful to improve consumer relevance and satisfaction including, for example, click rates, and generates a rank value for all relevant bids. The rank value generated by the bidding process determines if and where the manufacturer's advertisement will be delivered to the consumer in response to, for example, a scan performed by a POS terminal located at a retailer.

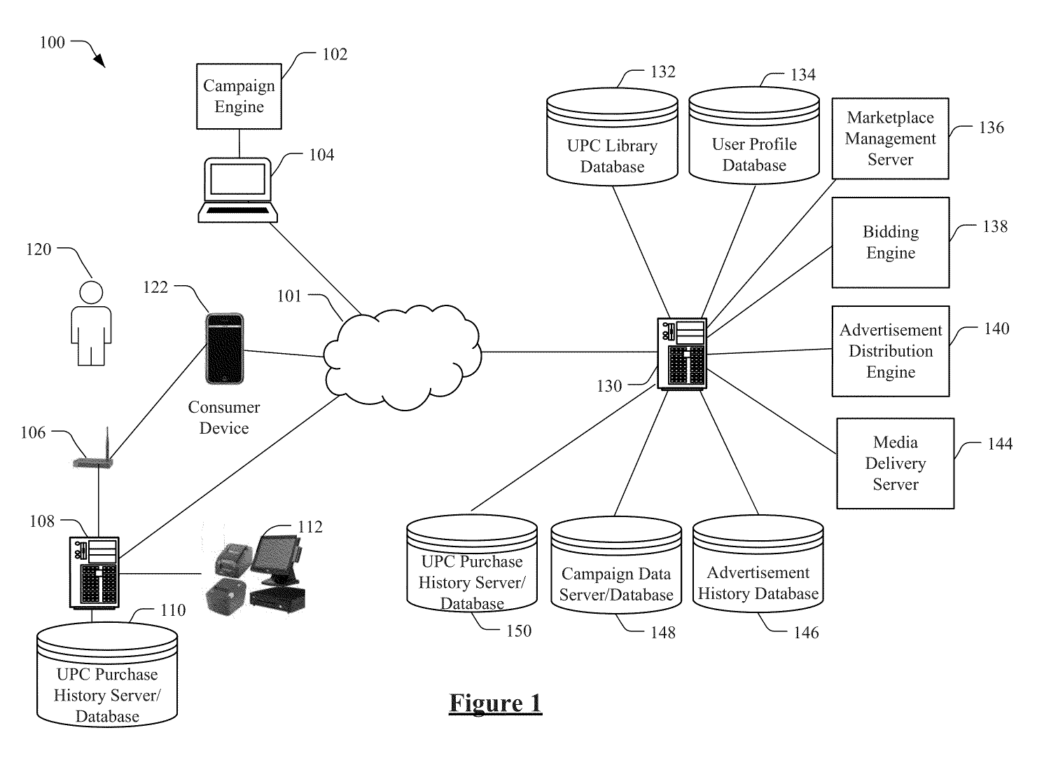

FIG. 1 illustrates an example of an infrastructure for providing targeted advertisements to a consumer by interfacing with a manufacturer, a retailer and a consumer, according to an embodiment of the present disclosure.

Referring to FIG. 1, a system 100 is illustrated for providing targeted advertisements, where the system 100 interfaces with a consumer, a manufacturer and a retailer via a network 101. Specifically, the system 100 includes a marketing computer 104, a server (e.g., a 12 Digit Media services server and/or servers) 130, a retail server 108 and a consumer 120 connected via a network 101.

The marketing computer 104 includes and executes a campaign engine 102, which can be hosted by, for example, the server 130. In an implementation, the campaign engine 102 can simply be a portal and/or browser, for example, that allows the marketing computer 104 to obtain and present information that is provided by the server 130. In another implementation, the campaign engine 102 may provide functionality that is beyond a portal and/or browser, such as performing operations based on information received from the server 130. Further, the server 130 includes and/or is connected to a UPC library database 132, a user profile database 134, a marketplace management server 136, a bidding engine 138, an advertisement distribution engine 140, a media delivery server 144, an advertisement/UPC history database 146, a campaign data server/database 148 and a UPC purchase history server/database 150. The entities included in or connected to the server 130 may be implemented as a single entity or as multiple entities and may not be limited to the functionality/structure described below and may perform the functions of other entities connected to the server 130. For example, any one of the above-described databases may be implemented by one or multiple databases, each being centrally located or each having different physical and/or virtual locations.

Further, the retail server 108 includes and/or is connected to a NFC device 106 used by retailers to communicate with the consumer 120 within or near a facility of the retailer, a POS terminal 112, and a UPC purchase history server/database 110. In an implementation, the retail server 108 manages many or all of the retail services required for consumer 120 purchases, and can communicate with the server 130 via the network 101.

In an implementation, a marketer (e.g., a manufacturer, a brand manager for a manufacturer, etc.) logs into the marketing computer 104 (e.g., a bidding terminal) to execute the campaign engine 102. The marketer can be directly employed by the manufacturer, or can have an arm's length relationship with the manufacture. The campaign engine 102 is the marketer's interface (e.g., portal) to the system 100, where the marketer can access a marketplace and create an account by inputting various fields of information. The marketer can then authenticate themselves and log into their confidential marketplace section. The marketer can search the UPC library database 132 for a specific category and sub-category of UPC codes, down to a UPC granular level, for which the manufacturer wants to bid. The marketer can also search the UPC library database 132 for a collection of UPCs, such as remnant UPCs for which advertisement delivery/exclusivity have not yet been sold, as targets for advertisement delivery.

A marketer is allowed to see all available data in their allowable categories and can run inventory analysis (e.g., view all brands, subsets/subcategories of brands, available inventory, etc.) on their allowable categories for the upcoming weeks. The marketer can pick and edit UPCs by category, subcategory, defined competitive set, and choose any exclusions such as large size, etc. The marketer can also set campaign location settings to define location/geography, and can input fields such as budget, min/max bid, expiration date, etc.

There are many options for bid strategies, such as manual versus automatic, campaign or group bid strategies, and flexible bids. A marketer can either manually set a description for each advertisement or run an automatic process and set up and edit as appropriate.

In another implementation, the marketer can enter the UPCs of the products they are promoting and their campaign goals. A campaign wizard of the campaign engine 102 can use and/or utilize information from the advertisement/UPC history database 146 and use and/or utilize predictive algorithms within the campaign data server/database 148 (which stores various information regarding previous and current campaigns, where collaborative filtering of other successful or unsuccessful campaigns may be performed) to recommend and/or obtain recommendations of UPCs (of, for example, remnant UPCs) to target. The marketer can review lists of all category/sub-category with all available UPCs in the UPC library database 132 and select or deselect those UPCs, including their own, that they want to use as triggers. The advertisement/UPC history database 146 can be used to generate projections on quantities of impressions (UPCs scanned) in an upcoming period of time such as, for example, the next few weeks. These projections can be used as input into (e.g., provided as information to be displayed using) the campaign engine 102 and my include: (i) capital budgets based on advertisements delivered; (ii) capital budgets based on units sold to consumers who have receive a related advertisement; (iii) an ability to help pace budgets evenly over some given number of days; (iv) a budget for each UPC selected; (v) a budget for the entire portfolio of UPCs or a specific group of UPCs; and (vi) altered budgets based on estimated ROI metrics.

Furthermore, other information can be entered into the campaign engine 102, such as: (i) a product graphic; (ii) a description; (iii) a quantity required for delivery of advertisement; (iv) an advertisement start date; and (v) advertisement end date. As discussed above, in an implementation, the campaign engine 102 may simply be a portal and/or browser to the server 130 that allows the above-described information to be sent to the server 130 using the marketing computer 104.

A user (e.g., a manufacturer, marketer, brand manager, etc.) that uses the marketing computer 104 can place/design a bid request based on one or more bid criteria such as cost per advertisement delivered, guaranteed placement, guaranteed delivery, cost per incremental unit sold that is related to the advertisement, tiered bids based on hitting specific volumes of the above metrics, frequency capping of delivered advertisements, so that, for example, a consumer is limited to receiving the same advertisement only a certain number of times over a certain time period.

The campaign wizard of the campaign engine 102 and/or presented using the campaign engine 102 as a portal/interface can run algorithms using the inputs from the user as well as historical response rates to advertisements for a category or specific UPS for this particular user along with consideration of other competitive bids already in the system 100 or anticipated upcoming bids based on historical patterns. The user can receive outputs and campaign suggestions such as: (i) an estimate of a likelihood of winning the bid (e.g. 25%, 50%, 75% or high/medium/low); (ii) an estimate of a quantity of winning bids at a given budget, with the current campaign inputs of bid price; (iii) total impressions won/delivered and campaign dollars spent versus budget; (iv) an estimate of cost per incremental units sold based on assumptions about incrementally of past campaigns at the UPC granular level or at a group UPC level; (v) suggestions for new inputs to increase chances of winning bid; and (vi) suggestions of alternative campaigns (e.g., different/revised triggers, different advertisement content, etc.) to meet the user's objectives.

Campaign reporting provided at marketing computer 104 at the UPC level or group level can include: impressions delivered; advertisement delivered as a result of a specific trigger or triggers; and optimal campaign design based on a combination of the metrics above resulting in the most units moved at the least cost. This campaign reporting can be provided at the marketing computer 104 via the campaign engine 102 providing and/or acting as a portal/browser to the server 130.

A user interface (e.g., a bidding interface) can be provided by the campaign engine 102 and the marketing computer 104, from and/or using information provided by for example, the server 130, and may include the following list of activities: account login; select from predetermined campaign objectives; select a UPC or UPCs for targeting; budgeting and cost/performance estimates; campaign setup; advertisement creation; launch campaigns; campaign reporting; bid optimization; real-time optimization recommendations; and campaign completion diagnostics and insights.

The marketplace management server 136 of the server 130 manages the overall process for bidding, advertisement distribution, and so on, by interfacing with, for example, the marketing computer 104 including the campaign engine 102 acting as, for example a portal and/or a browser. In some implementations, the campaign engine 102 may simply be a browser or portal that allows the marketing computer 104 to communicate with the server 130 and connect to the marketplace (e.g., online exchange) provided by the server 130. Further, the bidding engine 138 can be used by competing manufacturers, via for example other marketing computers 104 (e.g., bidding terminals) to bid on campaigns, UPCs, groups of UPCs, etc. defined and/or presented by the campaign engine 102.

Using the marketplace management server 136 and/or the bidding engine 138, manufacturers can submit bids that include information such as their brand, a list of all the UPCs they wish to trigger and deliver an advertisement to a consumer that purchases a product having the triggering UPC or UPCs, a timing date of a start/end of the delivery of the advertisement, a minimum and maximum bid price, geography and budget.

The bidding engine 138 and/or the marketplace management server 136 provide the bidding interface for the manufacturers. This bidding interface provides each manufacturer with a (online) user interface for creating manufacturer specific accounts, entering bids and managing campaigns. Each manufacturer can do this using their own marketing computer 104 (e.g., bidding terminal). In an implementation, for example, a user (e.g., manufacturer) must first create an account and then create a campaign. The campaign may, for example, identify a specific start date of the campaign, identify a specific end date of the campaign, identify a specific target (e.g., a specific UPC or a group of UPCs from an available collection of UPC data and/or remnant UPC data), and provide an interface for submitting a bidding price or prices. Further, by using the bidding interface, a user can view campaign results real-time and use the results to optimize future campaigns. The bidding interface may be provided to the user by way of a graphic user interface provided by the marketplace management server 136 and/or the bidding engine 138 or may be provided to the user by way of an application programming interface (API).

The bidding interface may also provide input fields related to the user (e.g., manufacturer) account and related to the manufacturer's campaign(s). For example, regarding the user account, the bidding interface can provide input fields for a “user name,” a “password,” an “email address,” a “company name,” an “address,” and “payment information.” Regarding the campaign, the user can be provided with input fields so that the user can input a “campaign name,” a “start date,” and “end date,” “a campaign objective,” a “target UPC list,” a “bid price”, a “maximum spend per day,” a “total spending limit,” and “advertisement details.” Additionally, in an implementation, the bidding interface will allow the user to specify a description of (e.g., the contents of) the advertisement, an image related to the advertisement, and a UPC of a product or related to the product identified by the advertisement.

In an implementation, the bidding interface can provide, as discussed above, campaign results. The campaign results can include/identify various metrics, such as advertisements delivered to consumers, a number of unique users receiving an advertisement, a total amount of money spent on a campaign, and a cost per advertisement delivered (e.g., total amount spent on a campaign divided by the number of advertisements delivered).

Furthermore, in an implementation, the metrics can be provided to the user via the bidding interface based on activity during a specific time period (e.g., between two specific dates), based on activity for a specific UPC or UPCs, based on a general category or based on a specific retailer or retailers.

During a bidding process, bids of manufacturers can be scored, ranked and prioritized for delivery based on the following sample collections of algorithms: (i) bid rate/amount (e.g., highest bid for delivery of an advertisement); and (ii) bid rate/amount×historical or projected rate at which a purchase is made by a consumer who receives an advertisement. In other words, the bids (e.g., bid scores) can be tracked by the server 130 so that the server 130 can determine the winning bidder at the appropriate time. The ranking of the various bids can be based on one or several algorithms to develop a bidding score (e.g., the above-mentioned bid-scores) for each of the participating manufacturers and then the winning bidder can be determined at the appropriate time.

Additionally, manufacturers can utilize the marketplace management server 136 and/or the bidding engine 138 on a daily, weekly or monthly basis and bid for delivering advertisements the following period without the typical multiple month lead time required by offline and newspaper FSIs.

Manufacturers can also test a myriad of campaign strategies and view response metrics on a daily basis in dashboards provided by the marketplace management server 136 to measure ROI and apply real-time test and learn methodologies used by successful internet models as search engine marketing with Google Adwords®. This can be accomplished because this bidding process is implemented as an ongoing online auction for determining winning bidders.

In an implementation, the marketplace management server 136 can receive all of the campaign data, account data and bids from the bidding interfaces, as provided by the manufactures involved in the bidding process. The marketplace management server 136 then prioritizes/orders the bids from the manufactures based on the above-described scores and also, for example, based on relevance and value to the consumer. The above-described algorithms can be adjusted, for example, to give higher priority to certain of the above-described factors, such as bid rate/amount. The manufacturer having the bid with the highest priority can then be notified and the retailer/consumer will be provided with the appropriate advertisements at the appropriate times. Since, this bidding process can be implemented as an ongoing (e.g., continuous) online auction, the winning bidder may be determined just after the consumer scans the targeted (remnant and/or non-remnant) UPC as the POS terminal 112. After the winning bidder is determined, the advertisements will be delivered to the consumer 120 via the server 130 by way of the retail server 108 and the POS terminal 112. Alternatively, the advertisement may be delivered to the consumer 120 in an electronic format, as discussed in further detail below. In an implementation, only a predefined/predetermined maximum number of advertisements may be delivered to the consumer based on each visit to the POS terminal 112, where the predefined/predetermined maximum number can be different based on the type of delivery. These features will allow the consumer to only be eligible to receive, at most, a certain number of advertisements and/or messages as a result of the scanned UPCs. For example, there may be a maximum of 5 printed advertisements and a maximum of 25 electronic advertisements delivered to the consumer per visit to the POS terminal 112 for purchase. In view of the above, a scenario exists where there could be 50 UPCs scanned by the consumer that are eligible for advertisements, but only 5 (e.g., the top 5 of the 50 eligible) will be delivered in print form to the consumer. The top 5 may be determined using, for example, a bid score as discussed below in more detail.

Alternatively, in an implementation, the marketplace management server 136, the bidding engine 138, etc., may provide the manufacturer with a notification indicating that they are the winning bidder and may also provide option to elect (e.g., the manufacturer is provided with an election) whether or not to deliver an advertisement to a consumer if the manufacturer has won a bid that enables the manufacturer to send an advertisement (or have an advertisement sent) to the consumer. For example, the manufacturer can implement a defensive marketing strategy by electing to not send an advertisement to the consumer. This can be achieved, by example, providing the election results to the winning bidder (e.g., manufacturer) and allowing the winning bidder (e.g., manufacturer) to make an election as to which action to take next (e.g., not send any advertisement, or send a specific type of advertisement, etc.).

In an implementation, the marketplace management server 136 receives campaign rules via the bidding interfaces utilized by the manufactures. Further, for example, the UPC purchase history server/database 110 and/or the UPC purchase history server/database 150 can be accessed by the marketplace management server 136 to build a list of potential advertisements for each manufacturer based on targeting criteria provided by the corresponding manufacture in the bidding process. In an implementation, the UPC purchase history server/database 110 can be a copy of the UPC purchase history server/database 150 and vice-versa. Accordingly, the marketplace management server 136 can access the UPC purchase history server/database 110 and/or 150 to build the list of potential advertisements for each manufacturer based on the targeting criteria. This list of potential advertisement can include a user ID, an advertisement ID, a start date for delivery, and end date for delivery and additional advertisement details. Any changes that are made to the potential advertisement list can be published to the media delivery server 144 in real time.

The media delivery server 144 supports the delivery of advertisements. Specifically, in an implementation, the media delivery server 144 can send each advertisement to the server 130 as they are received from the marketplace management server 136 and the server 130 may send each advertisement to the retail server 108 and/or the consumer 120 if/when appropriate.

As previously mentioned, the campaign data server/database 148 can store information related to previous (e.g., historical) campaigns and ongoing campaigns. For example, the campaign data server/database 148 may store a campaign identification and information related thereto, such as event type, advertisements viewed/received, UPC(s) triggering advertisements, dates and times related to the advertisements and retailer identification associated with the advertisements.

The consumer 120 may receive the advertisement from the POS terminal 112 (e.g., a printed advertisement) or may receive the advertisement by using an application (e.g., a 12 Digit Media application) that is installed on a handheld computer, table or smartphone (e.g., consumer device 122) of the consumer 120.

In an implementation, the application installed on the consumer device 122 is capable of storing and displaying advertisements targeted to the consumer 120. The application can further utilize the consumer device 122 to communicate with the retail server 108 via the POS terminal 112 and/or the NFC device 106, for example. In another implementation, the application can utilize the consumer device 122 to communicate with the server 130 to transmit/receive past user history and current/past advertisements. This application facilitates the easy viewing of one or multiple manufacturer advertisements from one application of one consumer device 122. These advertisements may also be accessible from multiple consumer devices for the convenience of the consumer 120. As an alternative to the application, the advertisements can be provided to the consumer 120 using online networks, email, direct mail, third-party applications and other user wearable devices.

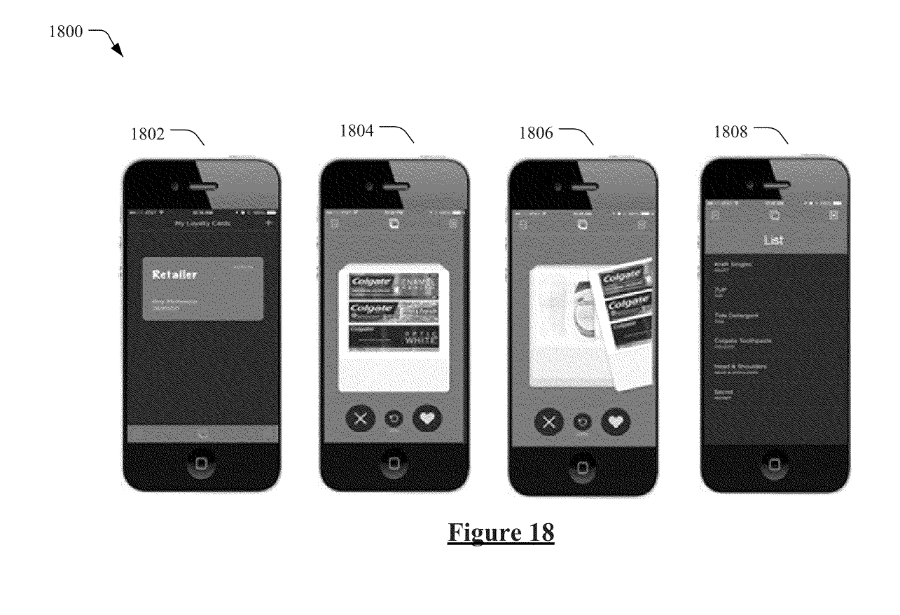

The application installed on the consumer device 122 may also allow the consumer 120 to create a user account, search for advertisements, view advertisement based on different criteria, such as expiration date, product category, manufacturer and issue date. Further, the application can also allow the consumer 120 to obtain previous purchase history from the retail server 108, via, for example, the NFC device 106 and/or the POS terminal 112, and also can allow the consumer 120 to transmit advertisement information to the retail server 108 for each relevant item purchased. In an implementation, the retailer may also be provided with an application and/or access to information provided by the server 130 to track and monitor the results of various campaigns and information associated therewith. Various aspects of the information that can be tracked by the retailer are discussed below with respect to FIG. 18.

In an implementation, the advertisement distribution engine 140 distributes advertisements to the consumers (e.g., the consumer 120) identified as targets for a campaign.

The UPC purchase history server/database 110 records consumer 120 purchases by UPC number, and all associated advertisements. For example, the UPC purchase history server/database 110 can store, in association with a unique user (e.g. the consumer 120) identification, the UPCs of items purchased by the consumer 120, the UPCs of items for which associated advertisements are available, and purchase dates. From this above-described information stored by the UPC purchase history server/database 110 and/or 150, determinations can be made as to the likelihood of the consumer 120 purchasing a product related to an advertisement and the likelihood or propensity that the consumer 120 will switch products based on their lifetime history and value. Further, the UPC purchase history server/database 110 can reside on the retailer side (e.g., can be connected to the retail server 108), may reside as a part of a services suite of the server 130 or may be a copy of the UPC purchase history server/database 150 connected to the server 130 (as discussed above, the UPC purchase history server/database 110 may simply be a copy of UPC purchase history server/database 150 or vice-versa). The UPC purchase history server/database 110 may receive various UPC and/or advertisement related information from the consumer application via, for example, the network 101 or through a connection to a POS backend system (not illustrated).

In an implementation, the POS backend system (not illustrated) may include servers and/or databases connected to the UPC purchase history server/database 110 in order to transmit UPC purchase information (e.g., historical purchase information) in a situation where a connection between the POS terminal 112 or the NFC device 106 and the application installed on the consumer device 122 is not available.

In an implementation, the user profile database 134 stores user profiles for various consumers (e.g., consumer 120), various manufacturers, and various retailers utilizing the system 100.

In another implementation, the server 130 hosts and/or provides the functionality of any portion or all of the UPC library database 132, the user profile database 134, the marketplace management server 136, the bidding engine 138, the advertisement distribution engine 140, the media delivery server 144, the advertisement/UPC history database 146 and the campaign data server/database 148. The server 130 can include a plurality of physical and/or virtual servers, which may or may not necessarily be in the same physical location. The plurality of physical and/or virtual servers may perform various operations and provide the functionality of each above-described elements and/or may provide interfaces to connect and/or connect with each of the above-describe elements.

An example implementation of defining a campaign using the above-described system 100 is provided below. A user interaction with the system 100 can be described from a perspective of a Brand Manager (BM), who can use the system 100 in a number of ways. In an automatic mode, the system 100 can pick an advertisement for the BM. A minimum bid amount can be suggested by the system 100 for competitive reasons.

Additionally, the BM can use the above-described campaign wizard to help suggest numerous campaign strategies once key variables are entered such as financial objectives, etc. In other words, the bidding engine 138 may suggest bids to the BM, as well as reminders, estimated inventory, etc.

The BM can also query the marketplace through the marketplace management server 136 and get estimates of bidding win rates and impressions won for each of the campaign strategies. Further, the BM can input and upload various creative elements such as copy, fonts, images, graphics in predefined templates and wizards.

An example implementation of using the system 100 to go through a bidding process is provided below. The BM obtains an ability, via the bidding process, to provide an advertisement against (e.g., targeting) scanned UPCs. In some implementations, the bid is for a fixed price per placement of an advertisement.

As previously mentioned, the system 100 is capable of providing campaign analysis and management. Specifically, the campaign engine 102 in conjunction with the server 130 can also be used to perform and provide the campaign analysis and management. In an implementation, the BM can review any current or past campaigns per UPC, per UPCs, per category or per subcategory. The BM can run various campaign analysis reports (e.g. what was best performing advertisement, etc.) for every UPC and/or every campaign at a macro or micro level.

In an implementation, the BM can also run reports on dollars spent to date, budget allotted and remaining budget available. Trend reports highlighting how the BM is doing month over month and projection reports showing likely available inventory on a weekly basis over the next 6 months can also be created and presented to the BM.

In another example implementation, the bidding process implemented by the system 100 can have a hard stop time/date, for example, at noon on Thursday, Pacific Standard Time, each week. This format gives every participating manufacturer a fair opportunity before the hard stop time/date to review the status of their bids and to adjust their bids accordingly. This format will also give the manufacturers a specific deadline for implementing new strategies for the following week that did not work in the current/previous week. Alternatively, the bidding process may be configured to provide real-time bidding, with the bidding process ending each day or up to a point at which the consumer 120 has a product scanned at the POS terminal 112.

Further, in an implementation, the manufacturer bids can be evaluated using several different methodologies, such as impressions based, conversion based or both. Impressions based evaluations are performed based on the manufacturers' CPM bids and conversion based evaluations are performed based on predicted or actual experiential conversion rates (e.g., rates of consumers purchasing products for which they received an advertisement) and combining a bid amount with the conversion rates. Additionally, impressions based and conversion based evaluations can be combined and utilized for a bid by taking into account different targeting or delivery queues. Also, impressions based and conversion based evaluations can be combined and utilized for a bid by taking into account prices on impressions, but weighted by conversion rates. For example, as a result of considering the above-described methodologies for evaluating bids, consumers and/or specific advertisements having lower conversion rates may influence a result of a bid from a manufacturer (e.g., the bid score) and may influence a manufacturer's willingness to increase a bid amount.

In an implementation, the bidding process can provide a highly personalized interface, where bidding components and algorithms for developing the bid score can be provided to the manufacturers. Ultimately advertisements should be highly personalized, relevant and valuable to each unique consumer. Rule sets and algorithms can be created to provide an “automatic curation” of advertisements based on numerous factors including recency of category purchase, and dollar size of past purchases and/or current purchase.

Additional implementations of the system 100 may include: (i) a bidding rights module (not illustrated) configured to provide built in marketplace protections that only allow a manufacturer to bid within their own pre-defined category (e.g., a laxative manufacturer may not be allowed to promote an advertisement to non-laxative consumers or to a consumer who is not currently purchasing a laxative); (ii) a loyalty module (not illustrated) configured to provide built in marketplace protections that enable retailer specific rules around engaging consumer's loyal to a given brand (e.g., a retailer might not allow a Pepsi® advertisement to be delivered to a loyal Coke® buyer); (iii) a gamification module (not illustrated) configured to provide a fun and engaging interface for manufacturers to bid and see results of their bid in terms of conversions and units moved; (iv) a campaign module (not illustrated) configured to provide a concept of enabling automatic and/or programmatic campaign creation of bids, so that a manufacturer can include, within a budget, campaign objectives (e.g., reach current in-market consumers, and launch a new product), and/or UPCs most important to the manufacturer in terms of targeting, and so that suggested campaigns can be instantly created using, for example, a wizard and can be instantly presented for approval; (v) a correlation module (not illustrated) configured to correlate various rule sets in order to eliminate redundancy (e.g., if a given consumer triggers the same advertisement 3 times, the manufacturer only wants to deliver one advertisement to the consumer during a certain time period; this is also referred to as frequency capping); (vi) a bid timing module (not illustrated) configured to introduce a concept of timing of how bids are placed, how manufacturers are alerted/notified if they are not going to have a winning bid enough times to reach the manufacturer's campaign budget and goals (e.g., the module can provide a notification to the manufacturer that the manufacturer needs to increase their bid by XX amount); (vii) a distribution module (not illustrated) configured to determine which advertisements to provide to each individual consumer based on the relevancy of that advertisement to that consumer, and configured to determine how to stack/rank/position a given advertisement against other advertisements in a same category; and (viii) an expiration module (not illustrated) configured to allow manufacturers to enter an expiration date and allow the system 100 to expire/remove advertisements at the end of that date, and configured to extend the expiration of an advertisement if a consumer triggers the same advertisement, or with a given rule set the system 100 might not extend the expiration date and instead show an advertisement of a next highest bidding manufacturer.

Data security is an important feature of the system 100. Accordingly, in an implementation, data security of the system 100 can be increased by using encrypted communications between all components of the system 100 whenever a user (e.g., consumer 120) identification, a retailer identification, a manufacturer identification and/or an advertisement code are communicated. Additionally, all locally stored data on a consumer device 122 that has previously communicated with or is currently communicating with the system 100 can be encrypted. Further, the system 100 can use industry best practices to secure all networks and servers utilized by the system 100.

The bidding engine 138 and/or the marketplace management server 136 can provide various alternative bidding options in some implementations of the present disclosure. Specifically, in an implementation, different bidding options can be provided, such as a standard bid and a performance bid. A standard bid is an amount a retailer is willing to pay to have an advertisement delivered to the target consumer (e.g., expressed in terms of “cost per thousand advertisements”). This type of bid can be used to provide premium guaranteed placement when there is limited inventory of a product (e.g., when there are only two or three manufactures of a particular type of product, the bidder will pay a premium to have the ability to target an advertisement to each person that purchases that product). Additionally, this type of bid can be used to provide premium guaranteed placement of advertisements at a future date, so that the manufacturer does not have to wait for bidding to commence and complete (e.g., the manufacturer may pay an upfront premium for an exclusive entitlement to deliver advertisements to one or more targeted UPCs without having to go through the bidding process). A performance bid is an amount a manufacturer is willing to pay for each product identified by an advertisement that was purchased by a particular consumer, where algorithms can be utilized to determine delivery and priority of each advertisement for the winning bidder. This bidding and a winning bidder can be determined prior to the consumer 120 scanning a particular UPC or can be determined in real time at the time which the consumer 120 scans the particular UPC.

Further, in an implementation, the system 100 can include optimization algorithms for maximizing the relevance to the consumers. This can be accomplished by using the optimization algorithm to prioritize advertisements for each consumer. For example, each advertisement can be scored for each consumer based on a calculated propensity of that consumer purchasing a product related to the advertisement. Specifically, each advertisement can be scored using, for example, any or all of the following variables: age; income; gender; zip code; past purchases in the category of the advertisement; date since last purchase of the product for which the advertisement is provided; past advertisements viewed; retailers shopped by the consumer in the past; a time of day; a day of week; a current geolocation (to identify which retailer(s) is/are relevant); presence/location of beacon signals (to identify which aisles the consumer has shopped or is currently shopping); crowd source historical purchases based on consumers who received the same or similar advertisement triggered by a single UPC or group of UPCs; and collaborative filtering used to prioritize advertisements (e.g., other people who received an advertisement triggered by the same UPC also purchased a product related to the advertisements). Higher scoring advertisements can be, for example, more prominently displayed in the application running on the consumer's device 122.

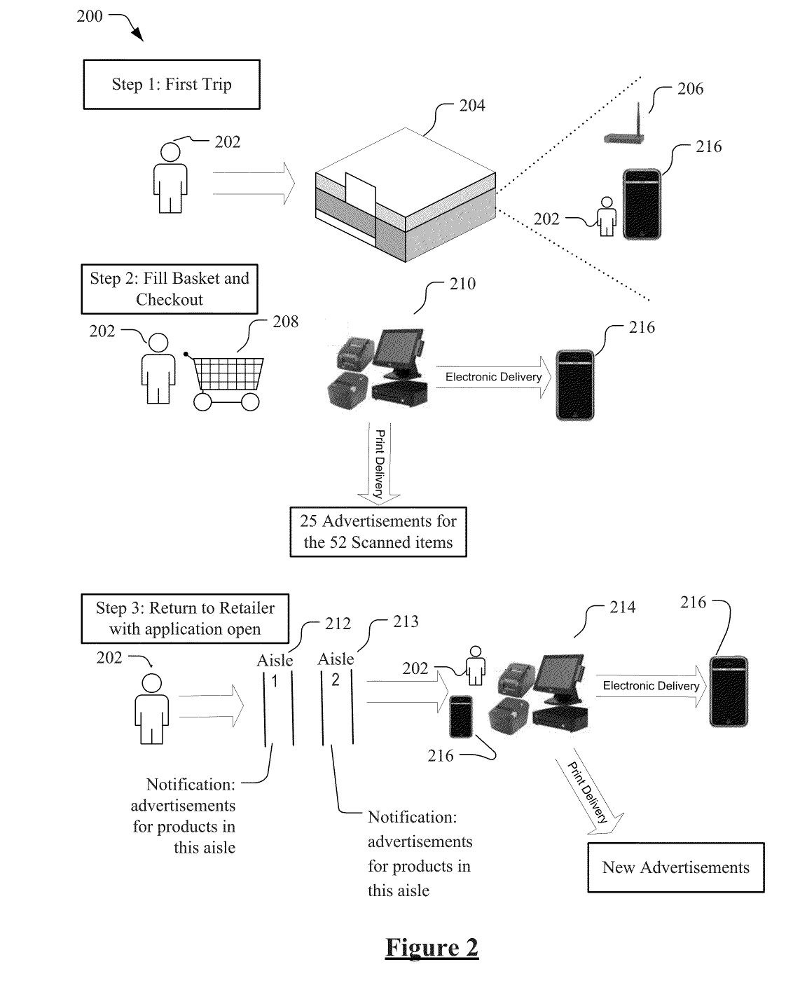

FIG. 2 illustrates one implementation of a process cycle for a consumer.

Referring to FIG. 2 an implementation of a process cycle 200 for a consumer is illustrated and is broken down into three steps.

The first step (e.g., “first trip”) in the process cycle 200 can occur in a variety of places. In this implementation, a consumer 202 enters a retailer 204, where the consumer 202 encounters an NFC device 206 (e.g., the NFC device 106 of FIG. 1) and where the consumer 202 is provided the opportunity to download an application (e.g., a 12 Digit Media application) onto a portable device 216, such as a tablet or smartphone. Alternatively, the consumer 202 may have previously downloaded the application at the retailer 204 or another location, such as the consumer's residence, place of work, by using, for example, an online application store.

After downloading and installing the application onto the portable device 216, the consumer 202 is provided the opportunity to register with the server 130 (e.g., the 12 Digit Media service), as illustrated in FIG. 1, using a unique identifier and password combination. This unique identifier and password combination can be used to protect against fraud by ensuring that only the intended consumer is receiving the advertisements. The consumer 202 is also provided the opportunity to contribute data to the system 100, as illustrated in FIG. 1, such age, income bracket, zip code, etc. to better assist the system 100 in proving advertisements to the consumer 202.

In the second step (e.g., “fill basket and checkout”), the consumer 202 then collects items for purchase 208 (e.g., 52 items) and proceeds to a POS terminal 210 to have the items for purchase 208 scanned. These scanned items for purchase 208 (e.g., UPC scan data) as well as consumer data (e.g., consumer identification information, consumer loyalty card information, etc.) and other data, such as retailer related information, etc. can be identified as shopping cart data, all of which can be transmitted from the POS terminal 210 and/or the retail server 108 to the server 130. In one implementation, the POS terminal 210, the retail server 108, as illustrated in FIG. 1, or other server related to a selling cycle of the items for purchase 208 notifies the server 130 of the scanned items for purchase 208 that were just purchased by the consumer 202, while, for example, the consumer 202 is at the POS terminal 210 (e.g., this is performed in real time while the consumer 202 is at the POS terminal 210). In this example, 25 of the items purchased by the consumer are products for which UPCs have been added to one or more manufacturers campaigns based on, for example, winning bids of the one or more manufacturers, and which are stored in the campaign data server/database 148, as illustrated in FIG. 1. In an implementation, these winning bids can be based on, the scanned items for purchase 208 (e.g., currently scanned UPCs) and based on historically scanned UPCs (e.g., previously purchased items). For example, a winning bid can be based on an item that the consumer 202 purchased in a previous day, week or month. This historical information (e.g., the historically scanned UPCs) can be stored, for example, in the UPC purchase history server/database 110 and/or 150. The advertisement distribution engine 140, of the system 100 illustrated in FIG. 1, then transmits 25 advertisements as defined in the campaign data server/database 148 to the consumer 202 electronically to the application on the portable device 216 of the consumer 202 or in a printed version, and records the distribution in the advertisement/UPC history database 146.

In the third step (e.g., “return visit”), on a subsequent trip to the retailer 204, the consumer 202 now has the advertisements they received as a result of their first visit available in an electronic format via the application or in a printed format. In an implementation, as the consumer 202 visits a specific aisle 212 or 213, the application of the portable device 216 can notify the consumer 202 that the consumer 202 has advertisements for items in aisle 1 212 and advertisements for purchasing items in aisle 2 213. These notifications may be provided at any point while the consumer 202 has the application of the portable device 216 open or they may be provided within the application of the portable device 216 as the consumer 202 is in the corresponding aisle by using strategically placed beacons. When the consumer 202 purchases products during this step, new advertisements maybe delivered electronically and/or in printed from a POS terminal 214 based on the products purchased.

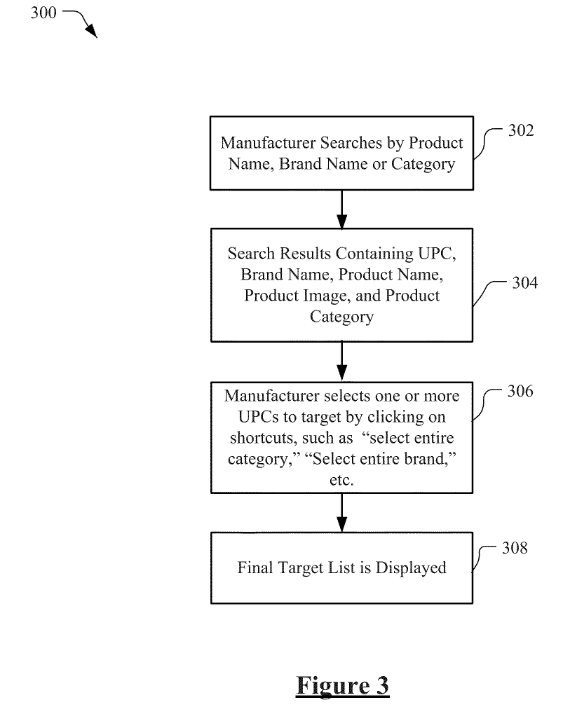

FIG. 3 illustrates a flowchart describing a UPC targeting process by a manufacturer, according to an embodiment of the present disclosure.

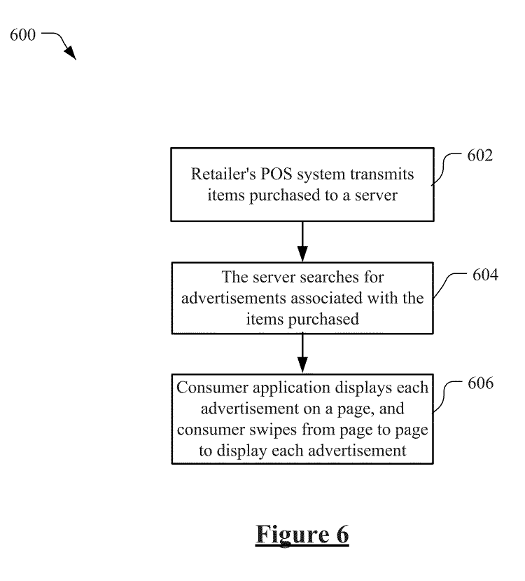

Referring to FIG. 3, a flowchart 300 including various operations is illustrated to describe a UPC targeting process (e.g., an (ongoing) online bidding process) by a manufacturer. Specifically, in operation 302 the manufacturer searches the UPC library database 132, as illustrated in FIG. 6, by product name, brand name, category, UPC, etc. The manufacturer can create customized categories, browse the results and refine brands based on multiple attributes.

Results of the search by the manufacture are displayed/provided to the manufacturer in operation 304. Depending on variables used to perform the search, results may include UPC(s), brand name(s), product name(s) and product category(ies) accumulated, for example, in a list.

In operation 306, the manufacturer is provided the opportunity to select one or more of the UPCs included in the list as targets for a campaign. A single UPC may be selected to target advertisements at a UPC granular level or multiple UPCs may be selected to target advertisements based on a group of UPCs. Rather than selecting each UPC, the manufacturer may be provided with shortcuts to select an entire category, select an entire brand, etc.

After the manufacturer selects the one or more UPCs in operation 306, a final target list is then presented to the manufacturer for use in subsequent phases of the targeting process in operation 308.

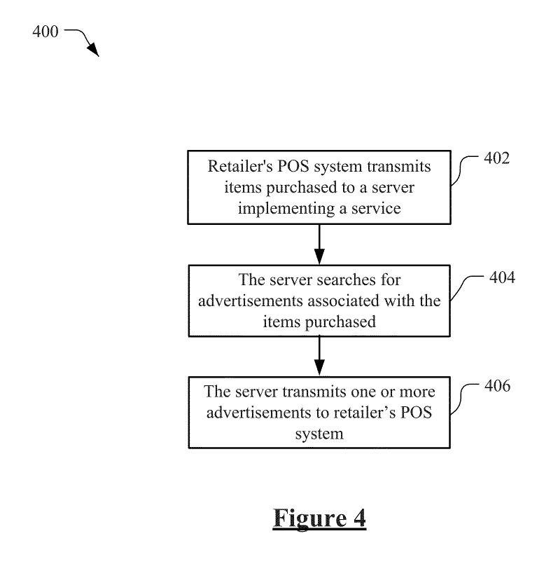

FIG. 4 illustrates one implementation of an advertisement delivery process by a retailer, according to an embodiment of the present disclosure.

Referring to FIG. 4, a flowchart 400 including various operations is illustrated to describe an advertisement delivery process performed by a retailer. Specifically, in operation 402 the retailer may utilize a POS system to transmit a list of items purchased by a consumer to, for example, the server 130, as illustrated in FIG. 1, for implementing a service.

Next, in operation 404 the server 130 searches for the advertisements that have been associated with the consumer based on, for example, previously collected shopping cart data of the consumer and advertisements that were issued for the items purchased based on various bids from manufacturers.

Based on the results of the search performed in operation 404, the server 130, as illustrated in FIG. 1, transmits one or more advertisements to the retailer's POS system and then records their delivery in operation 406. Accordingly, in this implementation, the server 130 essentially keeps track of the advertisements that have been provided to the consumer and then provides the appropriate advertisements to the retailer's POS system while the consumer is completing their purchase.

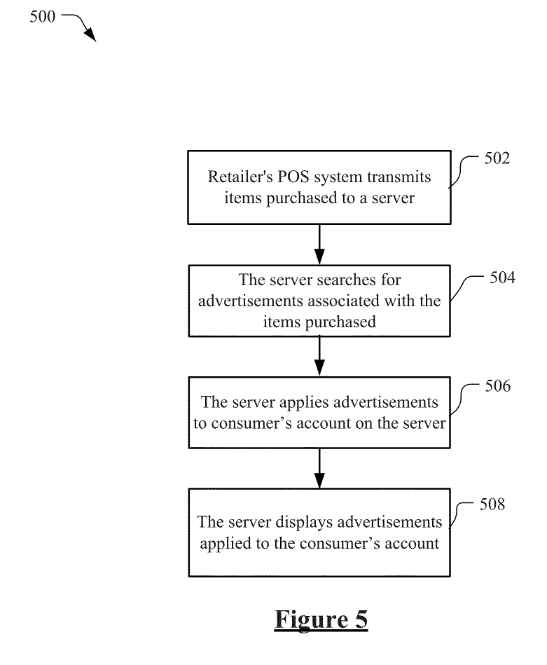

FIG. 5 illustrates a process of adding advertisements to a consumer's account, according to an embodiment of the present disclosure.

Referring to FIG. 5, a flowchart 500 including various operations is illustrated to describe a process of adding advertisements to a consumer's account (e.g., a consumer's user account). Specifically, in operation 502 a retailer may utilize a POS system to transmit a list of items purchased by a consumer to, for example, the server 130, as illustrated in FIG. 1, for implementing a service. This list of items may be identified as shopping cart data. The shopping cart data may also include, for example, consumer data (e.g., consumer identification information, consumer loyalty card information, etc.).

Next, in operation 504 the server 130 searches for the advertisements that are associated with the consumer based on, for example, the shopping cart data, and that are to be issued to the consumer for the items purchased based on various bids from manufacturers.

Based on the results of the search performed in operation 504, the server 130 applies the advertisements to a consumer's account on the server 130 in operation 506 in order to, for example, keep track of which advertisements have been provided to the consumer.

In operation 508 the server 130 displays the advertisements applied to the consumer's account on the server 130.

FIG. 6 illustrates one implementation of a process for a consumer receiving advertisements on a consumer application, according to an embodiment of the present disclosure.

Referring to FIG. 6, a flowchart 600 including various operations is illustrated to describe a process for a consumer receiving advertisements on a consumer application. Specifically, in operation 602 a retailer may utilize a POS system to transmit a list of items purchased by a consumer to, for example, the server 130, as illustrated in FIG. 1, for implementing a service.

Next, in operation 604 the server 130 searches for the advertisements that are associated with the consumer based on, for example, shopping cart data including a list of UPC items, consumer identification, etc., and that are to be issued to the consumer for the items purchased based on various bids from manufacturers.

Based on the results of the search performed in operation 604, the consumer application associated with the server 130 displays each advertisement on a page and allows the consumer to swipe from page to page (e.g., to swipe from right-to-left or left-to-right using a finger, pointing device, controller, etc. to change a page that is displayed) to display each advertisement in operation 606.

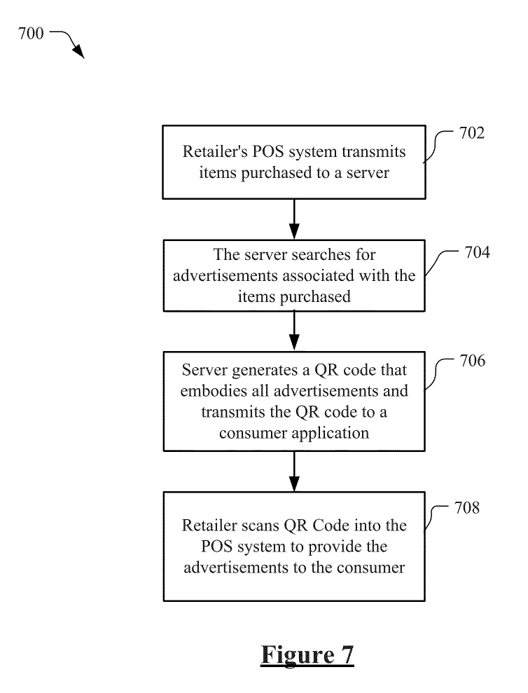

FIG. 7 illustrates one implementation of a process for a retailer to identify a batch of advertisements represented by a QR code, according to an embodiment of the present disclosure.

Referring to FIG. 7, a flowchart 700 including various operations is illustrated to describe a process of a retailer a batch of advertisements represented by a single QR code. Specifically, in operation 702 a retailer may utilize a POS system to transmit a list of items purchased by a consumer to, for example, the server 130, as illustrated in FIG. 1, for implementing a service. This list of items may be identified as shopping cart data. The shopping cart data may also include, for example, consumer data (e.g., consumer identification information, consumer loyalty card information, etc.).

Next, in operation 704 the server 130 searches for the advertisements that are associated with the consumer based on, for example, the shopping cart data, and that are to be issued for the items purchased based on various bids from manufacturers.

Based on the results of the search performed in operation 704, the server generates a QR code that embodies all advertisements and transmits the QR code to a consumer application associated with the server 130 in operation 706. Alternatively, rather than being a QR code, the code generated by the server may be a PDF417 code, a GS1 Databar code, a DataMatrix code, or any other two dimensional code

In operation 708, the retailer scans the QR code, as provided by the consumer into the POS system and the advertisements associated therewith are provided to the consumer at the POS.

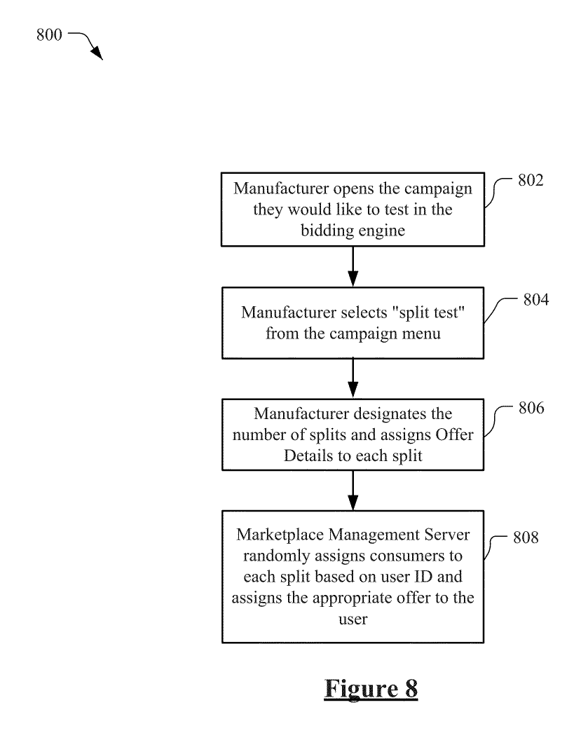

FIG. 8 illustrates a process of an A/B test configuration, according to an embodiment of the present disclosure.

Referring to FIG. 8, a flowchart 800 including various operations is illustrated to describe a process of an A/B test configuration, such as, for example a split test (e.g., split audition) or even a multivariate test (e.g., multivariate audition). Specifically, in operation 802 a manufacturer opens a campaign to be tested (e.g., auditioned) in the bidding engine 138, as illustrated in FIG. 1.

Next, in operation 804, the manufacture can select “split test” from a campaign menu provided by the bidding engine 138.

Then, in operation 806, the manufacturer can designate a number of splits and assign advertisement details to each split.

In operation 808, a marketplace management server 136, as illustrated in FIG. 1, randomly assigns consumers to each split based on their user ID and assigns the appropriate advertisement to the user.

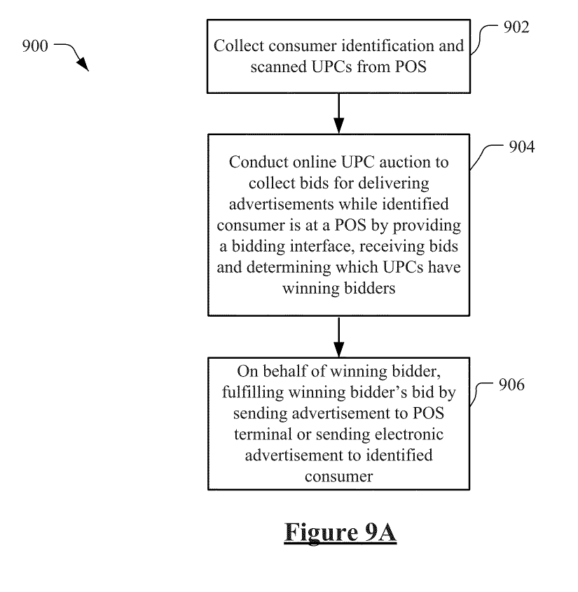

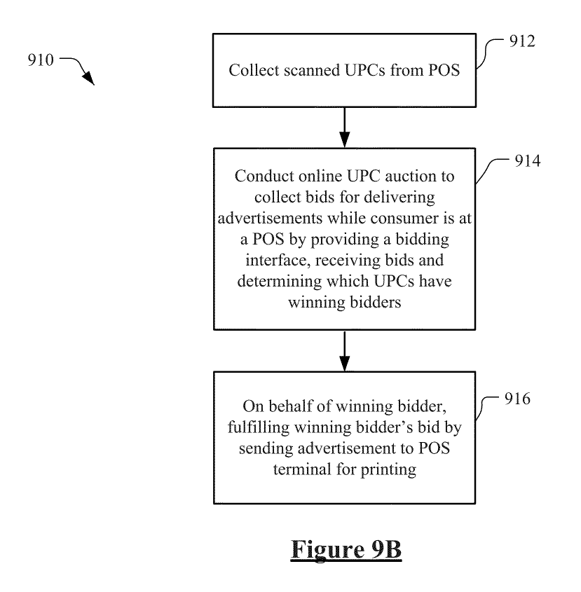

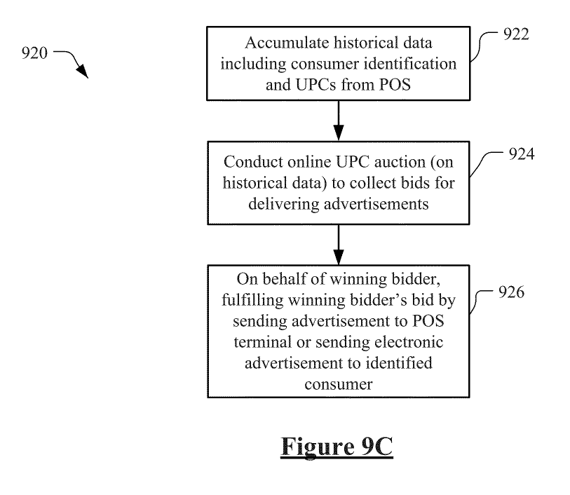

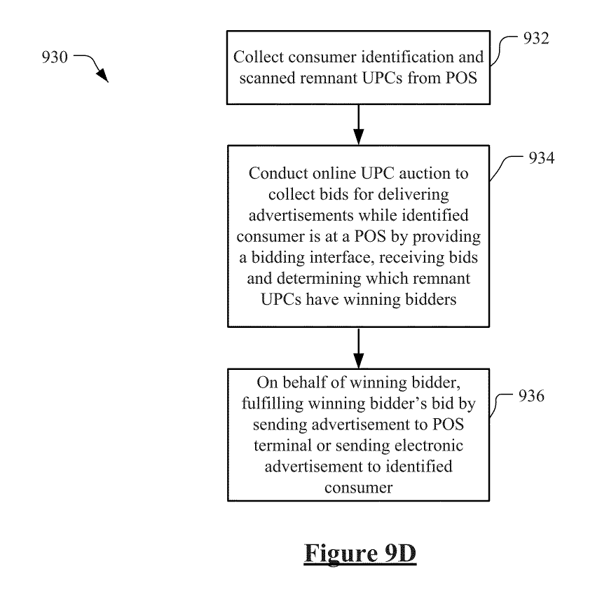

FIGS. 9A, 9B, 9C and 9D illustrate various implementations of providing one or more targeted advertisements to a consumer, according to various embodiments of the present disclosure.

Referring to FIG. 9A, a flowchart 900 including various operations is illustrated to describe a process of providing one or more target advertisements to a consumer. This process of providing the advertisements to the consumer is performed using consumer identification information (e.g., loyalty card information) and UPC information that is scanned while the consumer is currently at a POS terminal of a physical store.

In operation 902 the process collects a consumer's identification and scanned UPCs from the POS. Specifically, operation 902 may include, for example, collecting shopping cart data from numerous POS terminals (e.g., POS terminal 112, as illustrated in FIG. 1) in physical stores, the shopping cart data identifying the consumer (e.g., consumer 120, as illustrated in FIG. 1) using a unique consumer identification and identifying one or more UPCs 1 scanned while the identified consumer is present at one of the POS terminals.

In operation 904 the process conducts an online UPC auction (e.g., server 130, as illustrated in FIG. 1, conducts the auction) to collect bids for delivering advertisements while the identified consumer is at the POS by providing a bidding interface, receiving bids and determining which UPCs have winning bidders. More specifically, operation 904 may include, for example, conducting an online UPC auction to collect bids, by UPC or a group of UPCs, for delivery of advertisements to the identified consumer triggered by scanning of a UPC or UPCs in the physical stores, in which winning bids, if any, are determined as of the time the identified consumer is present at the POS terminal.

Referring to operation 904, in an implementation, a current winning bidder for a particular UPC is entitled to send their advertisement to the POS terminal for printing and/or send an electronic advertisement to the identified consumer, and the online UPC auction accepts bids and withdrawal of bids from bidding participants using bidding terminals (e.g., marketing computer 104 and campaign engine 102, as illustrated in FIG. 1), and determines the current winning bidder from among the bidding participants on an ongoing basis by performing the following:

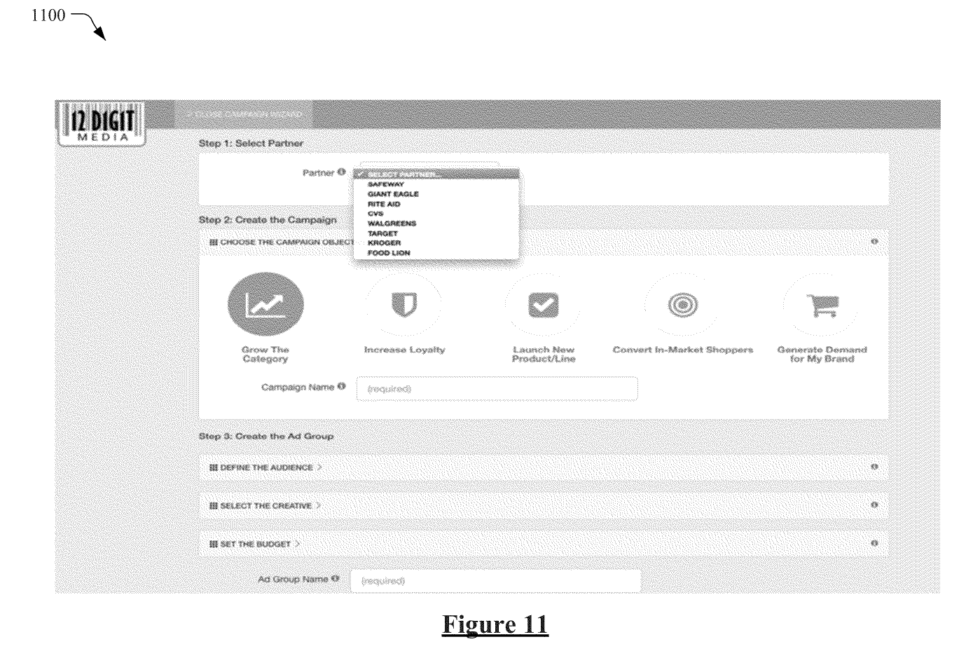

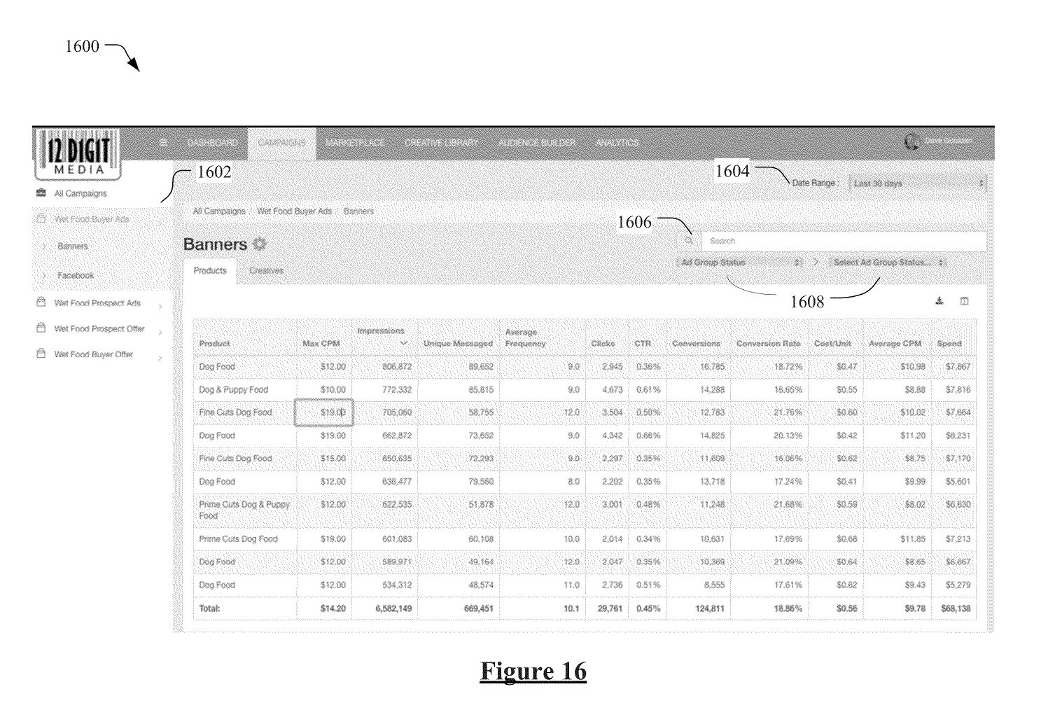

Providing a bidding interface (e.g., screenshots 1100, 1200, 1300 and 1400, as illustrated in FIGS. 11-14) to the bidding terminals that identifies the UPCs that are available through the online UPC auction; receiving from the bidding interface, bids on selected UPCs of the available UPCs, as well as, for example, bid effective dates, and advertisement descriptions (e.g., screenshots 1100, 1200, 1300 and 1400); tracking, for the selected UPCs, bid scores based at least in part on the bids on the selected UPCs (e.g., screenshot 1600, as illustrated in FIG. 16); and while the identified consumer remains present at the POS terminal, using at least the bid scores to determine a current best bid for a particular UPC and determining, among the one or more UPCs identified by the shopping cart data, which UPCs have winning bidders.

In operation 906 the process includes, on behalf of winning bidder and, for example, responsive to an election by the winning bidder, fulfilling the winning bidder's bid by sending an advertisement to the POS terminal or sending an electronic advertisement to the identified consumer. Specifically, operation 906 may include, for example, on behalf of a winning bidder and responsive to an election by the winning bidder, fulfilling the winning bidder's bid by, at least one of, sending the advertisement to the POS terminal for printing and sending the electronic advertisement to the identified consumer (e.g., “Step 2” and “Step 3,” as illustrated in FIG. 2).

Referring to FIG. 9B, a flowchart 910 including various operations is illustrated to describe a process of providing one or more target advertisements to a consumer. This process of providing the advertisements to the consumer is performed using UPC information that is scanned while the consumer is currently at a POS terminal of a physical store.

In operation 912 the process collects scanned UPCs from the POS. Specifically, operation 912 may include, for example, collecting one or more UPCs scanned while the consumer is present at one POS terminal of numerous POS terminals in physical stores (e.g., POS terminal 112 and consumer 120, as illustrated in FIG. 1).

In operation 914 the process conducts an online UPC auction (e.g., server 130, as illustrated in FIG. 1, conducts the auction) to collect bids for delivering advertisements while the consumer is at the POS by providing a bidding interface, receiving bids and determining which UPCs have winning bidders. More specifically, operation 914 may include, for example, conducting an online UPC auction to collect bids, by UPC or a group of UPCs, for delivery of advertisements to the consumer triggered by scanning of a UPC or UPCs in the physical stores, in which winning bids, if any, are determined as of the time the consumer is present at the POS terminal.

Referring to operation 914, in an implementation, a current winning bidder for a particular UPC is entitled to send their advertisement to the POS terminal for printing, and the online UPC auction accepts bids and withdrawal of bids from bidding participants using bidding terminals (e.g., marketing computer 104 and campaign engine 102, as illustrated in FIG. 1), and determines the current winning bidder from among the bidding participants on an ongoing basis by performing the following:

Providing a bidding interface (e.g., screenshots 1100, 1200, 1300 and 1400, as illustrated in FIGS. 11-14) to the bidding terminals that identifies the UPCs that are available through the online UPC auction; receiving from the bidding interface, bids on selected UPCs of the available UPCs, as well as, for example, bid effective dates, and advertisement descriptions (e.g., screenshots 1100, 1200, 1300 and 1400); tracking, for the selected UPCs, bid scores based at least in part on the bids on the selected UPCs (e.g., screenshot 1600, as illustrated in FIG. 16); and while the consumer remains present at the POS terminal, using at least the bid scores to determine a current best bid for a particular UPC and determining, among the one or more collected UPCs, which UPCs have winning bidders.

In operation 916 the process includes, on behalf of winning bidder and, for example, responsive to an election by the winning bidder, fulfilling winning bidder's bid by sending an advertisement to the POS terminal for printing. Specifically, operation 916 may include, for example, on behalf of a winning bidder and responsive to an election by the winning bidder, fulfilling the winning bidder's bid by sending the advertisement to the POS terminal for printing.

Referring to FIG. 9C, a flowchart 920 including various operations is illustrated to describe a process of providing one or more target advertisements to a consumer. This process of providing the advertisements to the consumer is performed using historical data including UPC information that is scanned while the consumer is currently at a POS terminal of a physical store and UPC data that has been collected and stored based on previous purchases. Specifically, this historical data may include past (e.g., historical) and present purchase information associated with the consumer. Accordingly, online auctions, as discussed below, can be performed on past and present/current UPC scan information.

In operation 922 the process accumulates historical data including consumer identification and scanned UPCs from the POS. Specifically, operation 922 may include, for example, accumulating, as historical data, shopping cart data from numerous POS terminals in physical stores, the shopping cart data identifying a consumer using a unique consumer identification and identifying one or more UPCs scanned while the identified consumer is present at one of the POS terminals (e.g., POS terminal 112 and consumer 120, as illustrated in FIG. 1).

In operation 924 the process conducts an online UPC auction on, for example, the historical data (e.g., server 130, as illustrated in FIG. 1, conducts the auction) to collect bids for delivering advertisements. More specifically, operation 924 may include, for example, conducting an online UPC auction to collect bids, by UPC or a group of UPCs, for delivery of advertisements to the identified consumer triggered by identification of the consumer at the POS terminal, in combination with the historical data that identifies UPCs of goods purchased by the identified consumer in the physical stores, in which winning bids, if any, are determined as of the time the identified consumer is present at the POS terminal.

Referring to operation 924, in an implementation, the online UPC auction is conducted using the one or more UPCs identified by the historical data collected in a historical period of at least one week and associated with the unique consumer identification of the identified consumer, a current winning bidder for a particular UPC is entitled to send their advertisement to the POS terminal for printing and/or send an electronic advertisement to the identified consumer, and the online UPC auction accepts bids and withdrawal of bids from bidding participants using bidding terminals (e.g., marketing computer 104 and campaign engine 102, as illustrated in FIG. 1), and determines the current winning bidder from among the bidding participants on an ongoing basis by performing the following:

Receiving from a bidding interface, bids on selected UPCs of UPCs that are available UPCs through the online UPC auction, as well as, for example, bid effective dates, and advertisement descriptions, the selected UPCs being included in the historical data; tracking, for the selected UPCs, bid scores based at least in part on the bids on the selected UPCs; and while the identified consumer remains present at the POS terminal, using at least the bid scores to determine a current best bid for a particular UPC and determining, among the one or more UPCs identified by the historical data, which UPCs have winning bidders.

In operation 926 the process includes, on behalf of winning bidder and, for example, responsive to an election by the winning bidder, fulfilling the winning bidder's bid by sending an advertisement to the POS terminal or sending an electronic advertisement to the identified consumer. Specifically, operation 926 may include, for example, on behalf of a winning bidder and responsive to an election by the winning bidder, fulfilling the winning bidder's bid by, at least one of, sending the advertisement to the POS terminal for printing and sending the electronic advertisement to the identified consumer (e.g., “Step 2” and “Step 3,” as illustrated in FIG. 2).

Referring to FIG. 9D, a flowchart 930 including various operations is illustrated to describe a process of providing one or more target advertisements to a consumer. This process of providing the advertisements to the consumer is performed using consumer identification information (e.g., loyalty card information) and remnant UPC information that is scanned while the consumer is currently at a POS terminal of a physical store. In another implementation, this process of flowchart 930 can be performed without using the consumer identification information, but still using the remnant UPC information. In other words, the consumer may not be specifically identified, but the remnant UPC information can still be used, as described in the following operations (e.g., the auction and fulfillment process regarding the remnant UPCs can be performed without having specifically identified the consumer and or the consumer's loyalty card information).

In operation 932 the process collects a consumer's identification and scanned remnant UPCs from the POS. Specifically, operation 932 may include, for example, collecting shopping cart data from numerous POS terminals (e.g., POS terminal 112, as illustrated in FIG. 1) in physical stores, the shopping cart data identifying the consumer (e.g., consumer 120, as illustrated in FIG. 1) using a unique consumer identification and identifying one or more remnant UPCs scanned while the identified consumer is present at one of the POS terminals.

In operation 934 the process conducts an online UPC auction (e.g., server 130, as illustrated in FIG. 1, conducts the auction) to collect bids for delivering advertisements while the identified consumer is at the POS by providing a bidding interface, receiving bids and determining which remnant UPCs have winning bidders. More specifically, operation 934 may include, for example, conducting an online UPC auction to collect bids, by UPC or a group of UPCs, for delivery of advertisements to the identified consumer triggered by scanning of a remnant UPC or remnant UPCs in the physical stores, in which winning bids, if any, are determined as of the time the identified consumer is present at the POS terminal.

Referring to operation 934, in an implementation, the remnant UPC or the remnant UPCs are a portion of available UPCs that have not been exclusively sold through a pre-auction channel, a current winning bidder for a particular remnant UPC is entitled to send their advertisement to the POS terminal for printing and/or send an electronic advertisement to the identified consumer, and the online UPC auction accepts bids and withdrawal of bids from bidding participants using bidding terminals (e.g., marketing computer 104 and campaign engine 102, as illustrated in FIG. 1), and determines the current winning bidder from among the bidding participants on an ongoing basis by performing the following:

Providing a bidding interface (e.g., screenshots 1100, 1200, 1300 and 1400, as illustrated in FIGS. 11-14) to the bidding terminals that identifies the remnant UPCs that are available through the online UPC auction; receiving from the bidding interface, bids on selected remnant UPCs of the available remnant UPCs, as well as, for example, bid effective dates, and advertisement descriptions (e.g., screenshots 1100, 1200, 1300 and 1400); tracking, for the selected remnant UPCs, bid scores based at least in part on the bids on the selected remnant UPCs (e.g., screenshot 1600, as illustrated in FIG. 16); and while the identified consumer remains present at the POS terminal, using at least the bid scores to determine a current best bid for a particular remnant UPC and determining, among the one or more remnant UPCs identified by the shopping cart data, which remnant UPCs have winning bidders.

In operation 936 the process includes, on behalf of winning bidder and, for example, responsive to an election by the winning bidder, fulfilling the winning bidder's bid by sending an advertisement to the POS terminal or sending an electronic advertisement to the identified consumer. Specifically, operation 936 may include, for example, on behalf of a winning bidder and responsive to an election by the winning bidder, fulfilling the winning bidder's bid by, at least one of, sending the advertisement to the POS terminal for printing and sending the electronic advertisement to the identified consumer (e.g., “Step 2” and “Step 3,” as illustrated in FIG. 2)

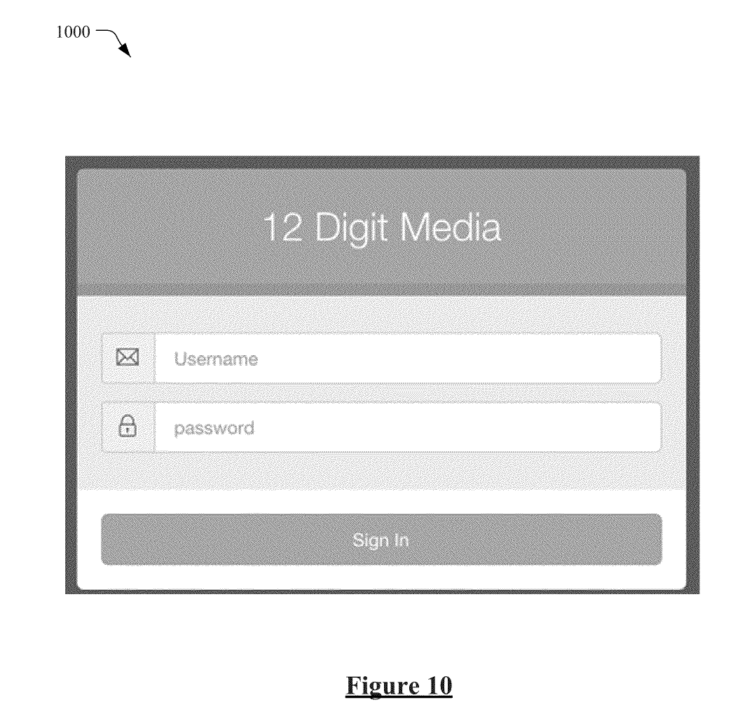

FIG. 10 illustrates an implementation of a login screen of an online exchange, according to an embodiment of the present disclosure.

Referring to FIG. 10, a login screen 1000 is presented to a user of the system 100, as illustrated in FIG. 1. Specifically, FIG. 10 illustrates that the login screen 1000 allows a user (e.g., a manufacturer, a brand manager representing an interest of a manufacturer, a retailer that sell products, etc.) to log into various aspects of an online exchange (e.g., marketplace, online auction, etc.) provided by the system 100 by entering a previously designated username and password and selecting “Sign In.” In an implementation, this online exchange is provided by 12 Digit Media. Various aspects of this online exchange, beyond the login screen 1000 are illustrated in FIGS. 11-17.

FIG. 11 illustrates an implementation of a campaign wizard of an online exchange for selecting a (retail) partner and choosing a campaign objective (e.g., a group of objectives) of a specific campaign, according to an embodiment of the present disclosure.

Referring to FIG. 11, a screenshot 1100 of a campaign wizard implemented by an online exchange (e.g., marketplace, online auction, etc.) is illustrated. As illustrated, in step 1 the campaign wizard allows a user (e.g., a manufacturer, BM, etc.) to select a partner (e.g., retailer) to which an advertising campaign will be directed. For example, FIG. 11 illustrates example partners, such as Safeway®, Giant Eagle®, Rite Aid®, CVS®, Walgreens®, Target®, Kroger®, Food Lion®, etc.

As illustrated in step 2, after the user selects their intended partner, the campaign wizard screenshot 1600 allows the user to select a campaign objective and to add a mandatory campaign name. Pre-loaded campaign objectives provided by the campaign wizard screenshot 1100 may include, “Grow The Category,” “Increase Loyalty,” “Launch New Product/Line,” “Convert In-Market Shoppers,” and “Generate Demand for My Brand.” Each of these campaign objectives will utilize different algorithms in order to better assist the user in the development of their campaign. For example, the objective “Increase Loyalty” may assist the user in targeting advertisements that will reward consumers that have been loyal to their brand, based on previous purchase data, etc. Accordingly, in an implementation, the user can bid, using historical data, on currently scanned UPCs and on historically scanned UPCs (e.g., UPCs scanned by a consumer on a previous visit), wherein this historic data can be utilized for bidding purposes for certain historical time periods, such as, for example, all UPCs scanned within the last week. On the other hand, the objective “Grow the Category” may assist the user to find consumers who through targeted advertisements will potentially grow a specific category of the user.

This campaign wizard provides a simple interface allowing the user to develop an objective-based campaign that matches the user's particular needs. Further, this interface provided by the online exchange will always be available for the user, so that the user can develop their strategy for targeting advertisements without time constraints, etc.

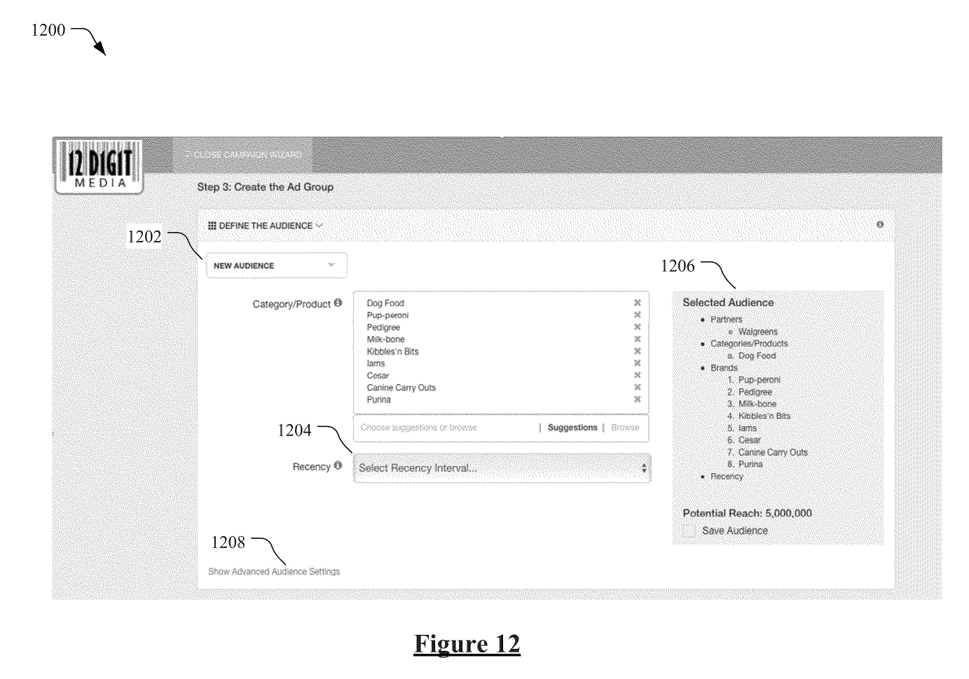

As illustrated in step 3, after the user selects their campaign objective and provides a name for their campaign, the user is able to create an advertisement group by defining (e.g., pre-defining) an audience, selecting the creative aspects of their campaign and setting a budget for their campaign. The campaign wizard also requires the user to identify a name for their advertisement group. The process of defining the audience is described below with reference to FIG. 12.

This screenshot 1100 and the information illustrated therein are merely examples and should not be limited by the data and/or options illustrated therein. Additional data and/or options may be provided to the user and/or customized by the user.

FIG. 12 illustrates an implementation of a campaign wizard of an online exchange for defining an audience of a specific campaign, according to an embodiment of the present disclosure.

Referring to FIG. 12, a screenshot 1200 of a campaign wizard implemented by an online exchange (e.g., marketplace, online auction, etc.) is illustrated. As illustrated, the user is provided an opportunity to define a new audience or select a previously defined audience using dropdown menu 1202. If the user decides to define a new audience, the user can select a category/product to target from a list of suggestions provided by the campaign wizard or the user can browse various categories/products to which they would like to target their advertisements. Furthermore, the campaign wizard provides a dropdown menu 1204, which allows the user to select a recency interval, which is a timeframe in which a consumer may have purchased a product that falls within the category/product selected by the user. The campaign wizard also provides a summary 1206 of the selected audience which identified selected partners, categories/products, brands and recency interval selected by the user. The summary 1206 may provide information regarding the number of potential consumers that might be reached by the present campaign, and may provide the user the option to save the selected audience.

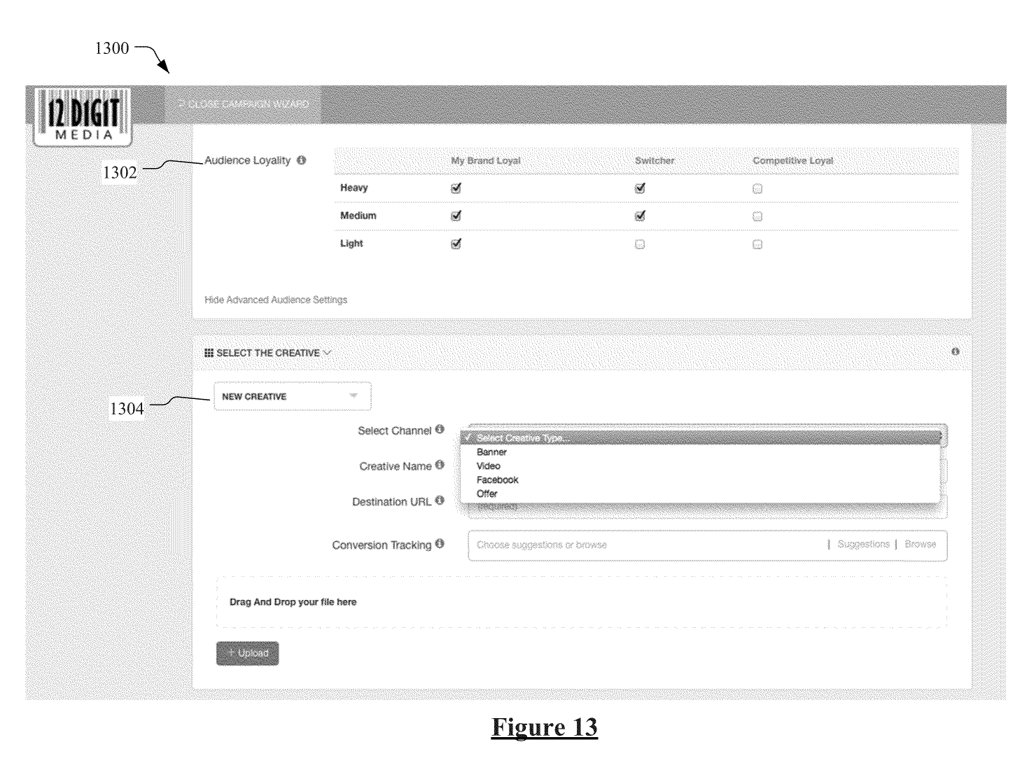

Moreover, the campaign wizard can provide the user with advanced audience setting options 1208 regarding the audience being defined by the user. These advanced settings are discussed below with reference to FIG. 13.

This screenshot 1200 and the information illustrated therein are merely examples and should not be limited by the data and/or options illustrated therein. Additional data and/or options may be provided to the user and/or customized by the user.

FIG. 13 illustrates an implementation of a campaign wizard of an online exchange for defining audience loyalty and selecting a type of advertisement to be provided for a specific campaign, according to an embodiment of the present disclosure, according to an embodiment of the present disclosure.

Referring to FIG. 13, a screenshot 1300 of a campaign wizard implemented by an online exchange (e.g., marketplace, online auction, etc.) is illustrated. As illustrated, if the user chooses to view the advanced audience settings, as discussed above with reference to FIG. 12, the user is provided the opportunity to define audience loyalty 1302 (e.g., various characteristics of the audience to be targeted based on their loyalty). For example, the user can select whether to include audience members (e.g., customers/consumers) who have heavy brand loyalty, medium brand loyalty or light brand loyalty. The user can select any or none of heavy, medium and light. Further, as illustrated, the user can select whether to include audience members who are heavy switchers (e.g., consumer who switch brands based on price, availability, etc.), medium switchers or light switchers. Additionally, as illustrated, the user can select whether to include audience members who have heavy loyalty to a competitor, medium loyalty to a competitor or light loyalty to a competitor.

Additionally, as illustrated in FIG. 13, when selecting the creative aspect of the campaign, the user is provided with a dropdown menu 1304 that allows the user to define a new creative (e.g., advertisements) or select a previously defined creative. If the user decides to define a new creative, the user will be able to select a channel, such as banner, video, Facebook®, offer, etc. In this implementation, the user will select “offer” in order to create a campaign that provides targeted advertisements. Moreover, the user is provided the opportunity to define a name of the new creative, add a destination URL if appropriate and to upload/add a file that includes, for example, the contents of the advertisement to be delivered to the consumer.

This screenshot 1300 and the information illustrated therein are merely examples and should not be limited by the data and/or options illustrated therein. Additional data and/or options may be provided to the user and/or customized by the user.

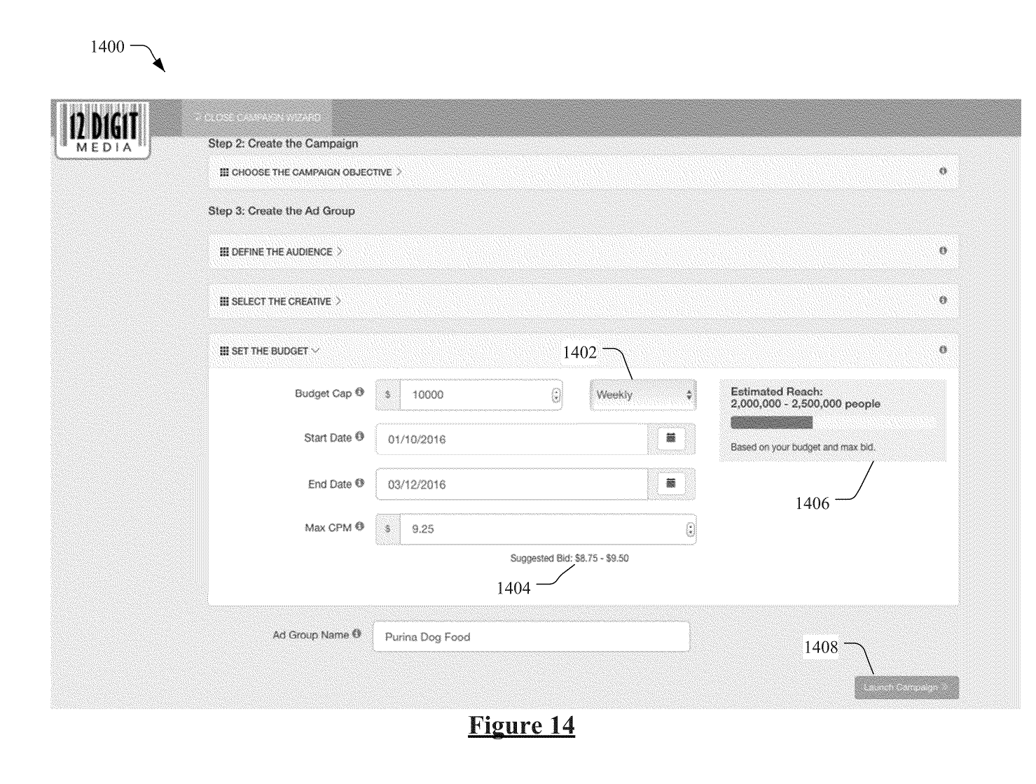

FIG. 14 illustrates an implementation of a campaign wizard of an online exchange for setting a budget and timeframe (e.g., a budget that is valid and/or can be used for an adjustable increment of time) for a specific campaign, according to an embodiment of the present disclosure.

Referring to FIG. 14, a screenshot 1400 of a campaign wizard implemented by an online exchange (e.g., marketplace, online auction, etc.) is illustrated. As illustrated, the user is provided an opportunity to set budget criteria, such as a budget cap, a start date, an end date and a maximum CPM. The budget cap can is the maximum amount the user wants to spend on a campaign. The user can decide, using dropdown menu 1402, a duration (e.g., daily, weekly, monthly, quarterly, yearly, etc.) for which the budget cap applies. For example, the user may set a maximum budget of $10,000 per week, as illustrated in FIG. 14. Additionally, the campaign wizard provides a suggested bid range 1404, using, for example, algorithms that take into account various factors discussed in detail above, such as the UPC or UPCs targeted by the campaign, past bid results, current bidders, etc. While the user sets the budget criteria, the campaign wizard can provide an estimated reach (in terms of people) 1406 based on the set budget and the maximum CPM. Furthermore, the campaign wizard provides the “ad group name,” as discussed with reference to FIG. 11. Once the user has provided all of the necessary information to begin the campaign, as discussed above with reference to FIGS. 11-14, the user can click on a “Launch Campaign” button 1408 to launch the campaign and begin the automated bidding/auction process.

This screenshot 1400 and the information illustrated therein are merely examples and should not be limited by the data and/or options illustrated therein. Additional data and/or options may be provided to the user and/or customized by the user.

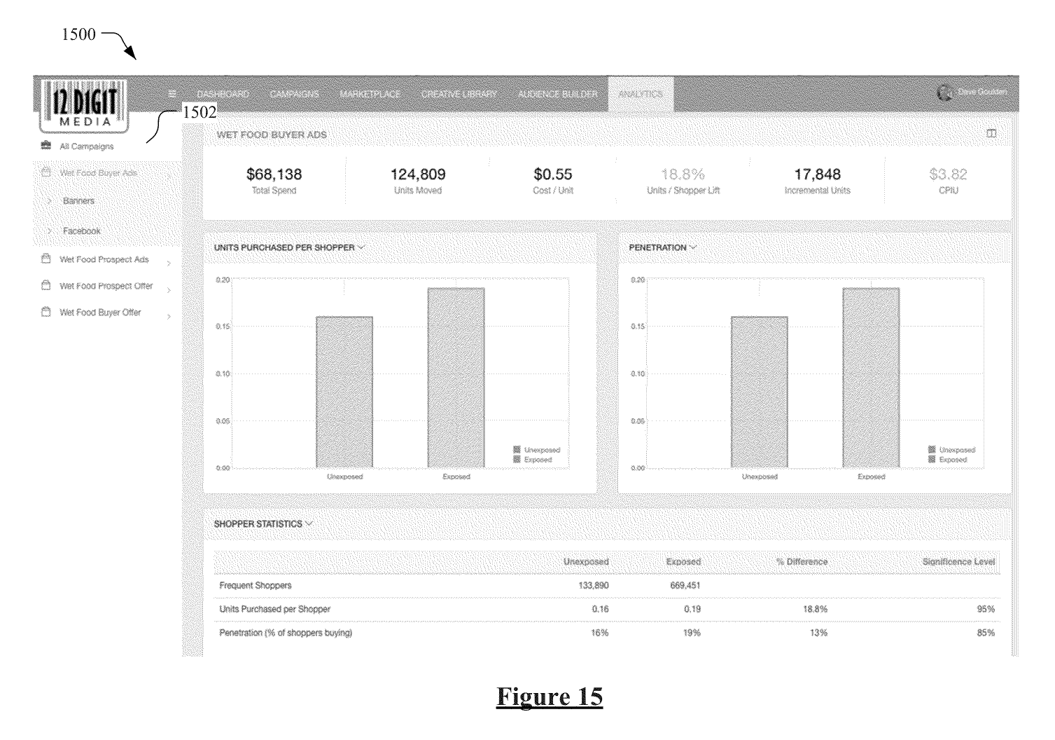

FIG. 15 illustrates a screenshot of an online exchange that provides real-time analytics for a specific campaign, according to an embodiment of the present disclosure.

Referring to FIG. 15, a screenshot 1500 of an analytics interface, as implemented by an online exchange (e.g., marketplace, online auction, etc.) is illustrated. Reference element 1502 identifies a left-hand column that allows a user to select which campaign(s) (e.g., all campaigns, wet food prospect offer, wet food buyer offer, etc.) for which the analytics are provided.

As illustrated in FIG. 15, the user, for example, has selected wet food buyer ads as the campaign for which the analytics are displayed. In this example, the user has spent a total of $68,138 on the campaign and has moved 124,809 units, resulting in an approximate cost per unit (e.g., advertisement) of $0.55. Further, FIG. 15 indicates that there has been an 18.8% shopper lift as a result of the campaign, which translates to 17,848 incremental units. As a result of this example campaign, FIG. 15 illustrates that the user on average has spent $3.82 per unit for the shopper lift.

The analytics can also provide a bar graph illustrating units purchased per shopper for consumers that have been exposed to the campaign and for consumers that have not been exposed to the campaign. Additionally, in an implementation, the analytics can provide a bar graph illustrating the difference in market penetration between consumers that have not been exposed to the campaign and consumers that have been exposed to the campaign.

Moreover, in an implementation, the analytics can provide a table that identifies (i) how many frequent shoppers (e.g., consumers) have been exposed and have not been exposed to the campaign, (ii) units purchased per unexposed shopper (iii) units purchases per exposed shopper, (vi) the percentage difference of units purchased between unexposed and exposed shoppers, (v) a statistical significance level of research confidence based on the level of percentage difference of units purchased per shopper, (vi) a penetration (e.g., percentage of shoppers buying) level for unexposed and exposed shoppers, (vii) and percent difference between the penetration of unexposed and exposed shoppers, and (viii) a statistical significance level of research confidence for the penetration level results.

These analytics are merely examples and additional analytics that are predefined by the online exchange and that are defined by the user may be provided by the online exchange.

FIG. 16 illustrates an interface of an online exchange that provides real-time monitoring and adjustment of a campaign(s), according to an embodiment of the present disclosure.

Referring to FIG. 16, a screenshot 1600 of an interface of an online exchange (e.g., marketplace, online auction, etc.) that provides real-time monitoring and adjustment of a campaign(s) is illustrated. Reference element 1602 identifies a left-hand column that allows a user to select which campaign(s) (e.g., all campaigns, wet food prospect offer, wet food buyer offer, etc.) for which the campaign information is provided.

In FIG. 16, a user has selected to display information regarding “Banners” for “Wet Food Buyer Ads.” In this example, each product of a targeted banner advertisement is listed in a product column. This same format discussed above and discussed below in further detail also applies when the user is implementing, for example, a targeted printed or electronic delivery advertisement campaign. As illustrated, for each product (e.g., dog food) a maximum CPM bid (e.g., $12.00) is provided, a number of impressions (e.g., 806,872) is provided, a unique messaged (e.g., 89,652) is provided, an average frequency (e.g., 9.0) is provided, a number of clicks (e.g., 2,945) is provided, a click-through rate (e.g., 0.36%) is provided, a number of conversions (e.g., 16,785) is provided, a conversion rate (e.g., 18.72%) is provided, a cost/unit (e.g., $0.47) is provided, an average CPM (e.g., $10.98) is provided and a spend amount (e.g., $7,867) is provided.

Furthermore, the screenshot 1600 illustrates that the user can select a date range 1604, search for terms 1606, and sort/filter by various criteria 1608.

This screenshot 1600 and the information illustrated therein are merely examples and should not be limited by the data and/or options illustrated therein. Additional data and/or options may be provided to the user and/or customized by the user.

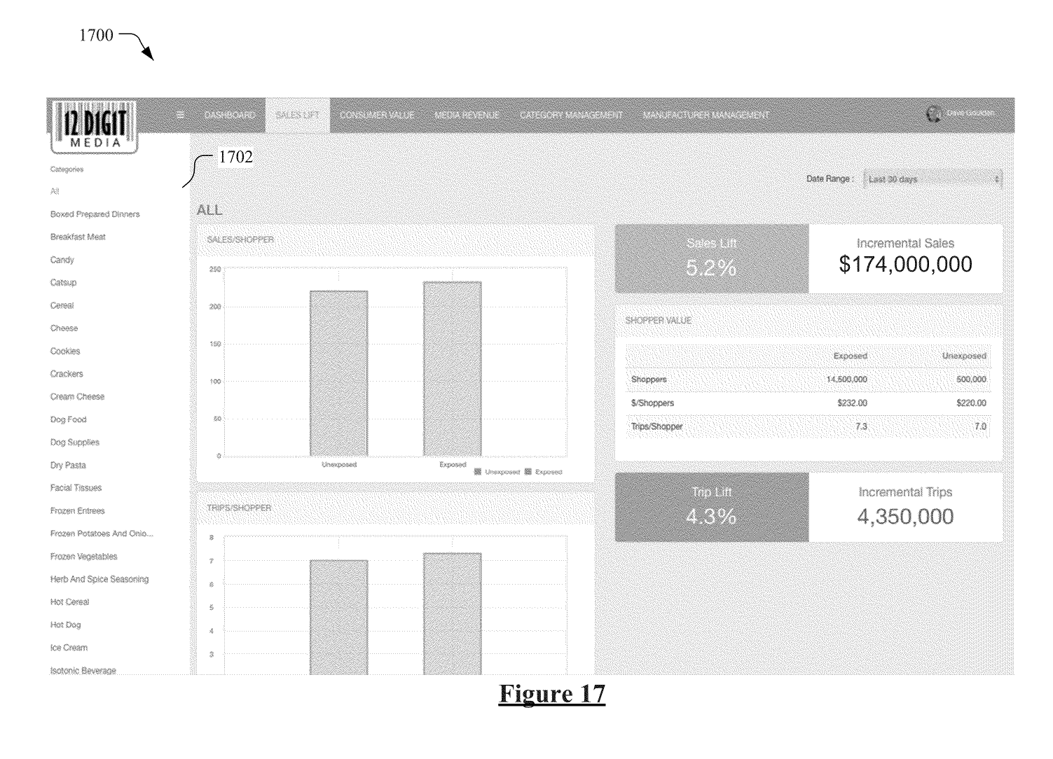

FIG. 17 illustrates an interface of an online exchange that provides real-time information regarding a lift of sales for a retailer, according to an embodiment of the present disclosure.

Referring to FIG. 17, a screenshot 1700 of an interface that provides sales lift information to a user, as implemented by an online exchange (e.g., marketplace), is illustrated. Reference element 1702 identifies a left-hand column that allows a user to select which campaign(s) (e.g., all campaigns, boxed prepared dinners, breakfast meat, etc.) for which the sales lift information is provided.

As illustrated in FIG. 17, the user, for example, has selected to view the sales lift information for all campaigns for the past 30 days. This sales lift information provides a bar graph illustrating sales per shopper for shoppers who are unexposed to the various campaigns and sales per shopper for shoppers who are exposed to the various campaigns. As illustrated in FIG. 17, as a result of all of the user's campaigns, there was a 5.2% sales lift for shoppers exposed to the campaigns, which produced an increase in incremental sales by $174,000,000.

Additionally, this sales lift information provides a bar graph illustrating trips per shopper for shoppers who are unexposed to the various campaigns and trips per shopper for shoppers who are exposed to the various campaigns. As illustrated in FIG. 17, as a result of all of the user's campaigns, there was a 4.3% trip lift (e.g., increase in number of trips per shopper) for shoppers exposed to the campaigns, which produced a total number of increases trips by 4,350,000 for the exposed shoppers.

FIG. 17 also illustrates a summary of shopper value as a result of the campaigns. This summary identifies the number of shoppers who were exposed to the campaigns and the number of shoppers who were not exposed to the campaigns. For the shoppers exposed to the campaigns, the summary indicates an average dollar amount spent per shopper and an average number of trips for each shopper for the past 30 days. Further, for the shoppers who were not exposed to the campaigns, the summary indicates an average dollar amount spent per shopper and an average number of trips for each shopper for the last 30 days.

The analytics can also provide a bar graph illustrating units purchased per shopper for shoppers that have been exposed to the campaign and for shoppers that have not been exposed to the campaign. Additionally, in an implementation, the analytics can provide a bar graph illustrating the difference in market penetration between shoppers that have not been exposed to the campaign and shoppers that have been exposed to the campaign.

This screenshot 1700 and the information illustrated therein are merely examples and should not be limited by the data and/or options illustrated therein. Additional data and/or options may be provided to the user and/or customized by the user.

FIG. 18 illustrates screenshots of a consumer application implemented on a smart phone, according to an embodiment of the present disclosure.

Referring to FIG. 18, screenshots 1800 of a consumer application implemented on a smartphone (e.g., the consumer device 122 of FIG. 1) are illustrated.

Referring to reference number 1802, a consumer application running on a consumer device is illustrated, where the consumer has entered their name and loyalty card information. Referring to reference number 1804, while the consumer application is running, the consumer can view various targeted advertisements that have been electronically delivered. For example, the consumer has received a targeted advertisement for various Colgate® products. The consumer has the ability to delete (e.g., reject) the advertisement by selecting the “X” button, identify the advertisement as a favorite (e.g., accept the advertisement) by selecting the “heart” button and the ability to undo a previous action by selecting the “undo” button.

Referring to reference number 1806, the consumer can also swipe through the various advertisements that are available through the consumer application. Referring to reference number 1808, once the consumer has viewed and selected all of their desired advertisements, a shopping list based on the advertisements can be created and emailed to the consumer as well.

These screenshots 1800 and the information illustrated therein are merely examples and should not be limited by the data and/or options illustrated therein. Additional data and/or options may be provided to the user and/or customized by the user.

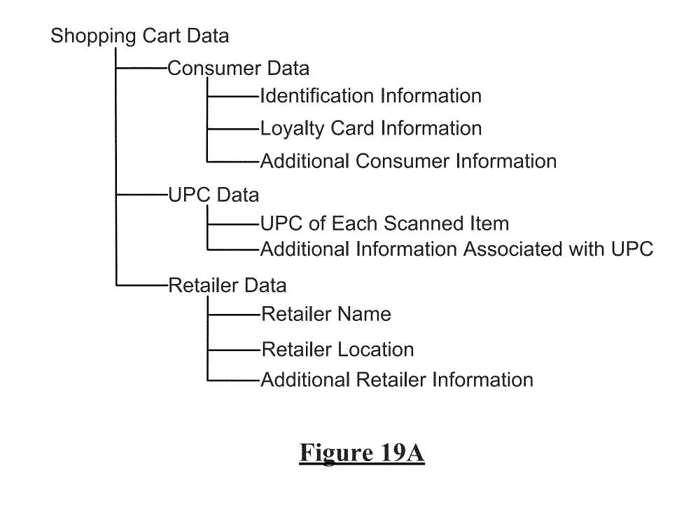

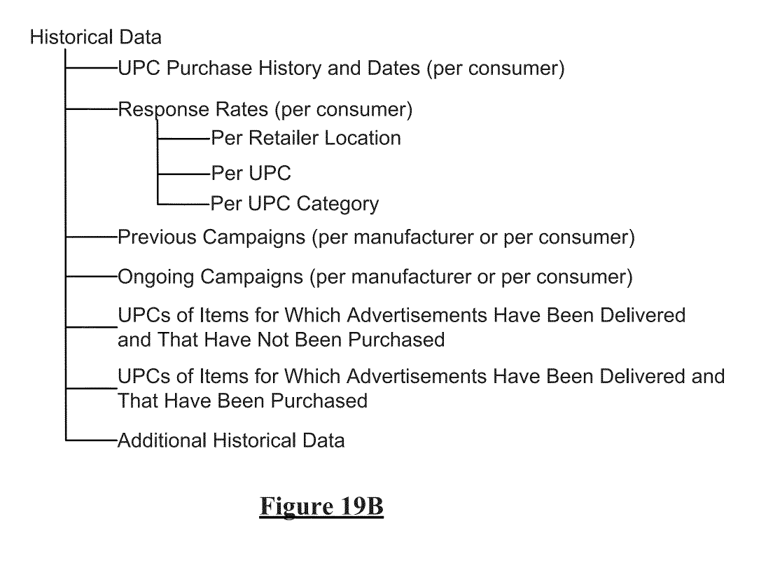

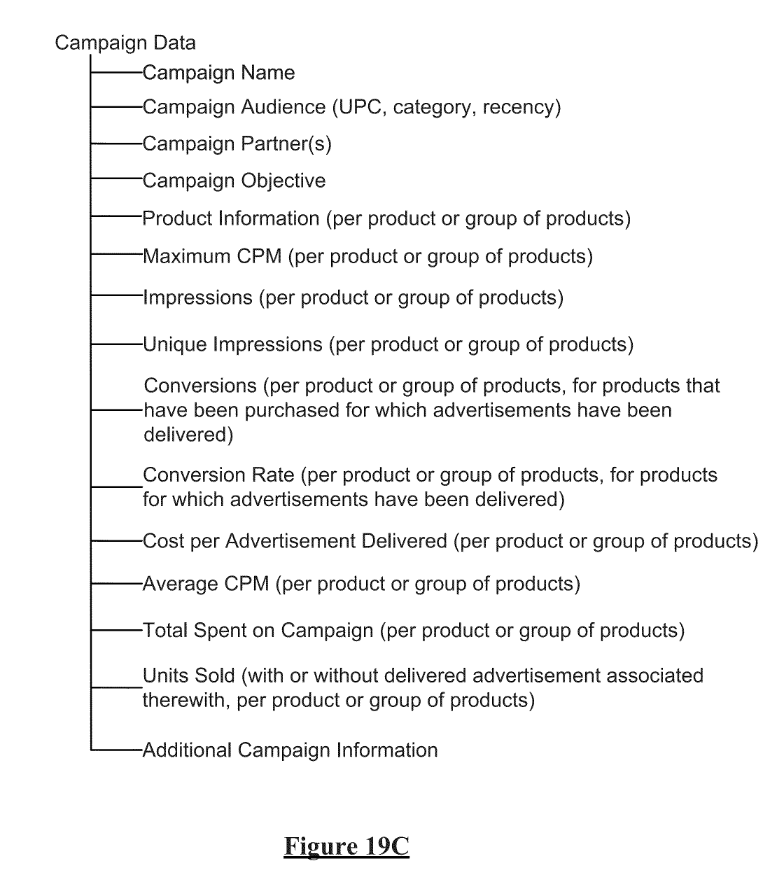

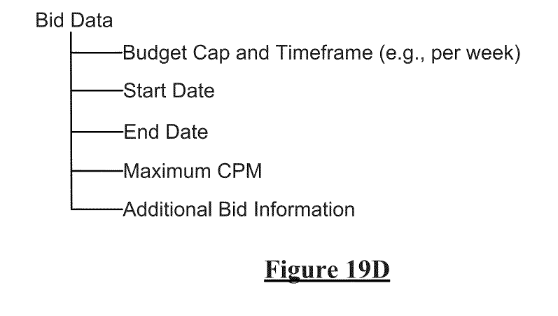

FIGS. 19A-19D illustrate data structures, according to various embodiments of the present disclosure.

Referring to FIG. 19A, a data structure of shopping cart data is illustrated.

Specifically, shopping cart data as discussed above with reference to various figures can include any or all of the following: consumer data; UPC data; and retailer data. Further, the consumer data may include identification information of the consumer, loyalty card information of the consumer, as well as additional consumer information related to the consumer. Additionally, the UPC data may include a UPC of each item scanned by, for example, a POS terminal while the consumer is at the retailer. Also, the UPC data may include additional information that is associated with the scanned UPCs. Moreover, the retailer data may include a retailer name of a retailer selling items that are scanned by the POS terminal (e.g., the retailer name may be identified as Safeway®). The retail data may also include a location (e.g., geographic region, etc.) of the retailer, as well as additional retailer information related to the retailer. In an implementation, this above-described data can be stored in any of the above-described databases, etc., of the system 100 illustrated in FIG. 1. This above-described data structure is not intended to limit the data that can be included in the shopping cart data, but is merely provided as an example implementation of an embodiment of the present disclosure.

Referring to FIG. 19B, a data structure of historical data is illustrated.

Specifically, historical data as discussed above with reference to various figures can include any or all of the following: UPC purchase history and dates (per consumer); response rates to advertisements (per consumer); previous campaigns (per manufacturer or per consumer); ongoing campaigns (per manufacturer or per consumer) UPCs of items for which advertisements have been delivered and that have not been purchased(per consumer); UPCs of items for which advertisements have been delivered and that have been purchased (per consumer); and additional historical data. Further, the response rates (per consumer) may identify the rates per retailer location, per UPC and per UPC category. In an implementation, some or all of the above-described historical data can be stored and/or retrieved based on loyalty card information of the consumer. In an implementation, this above-described data can be stored in any of the above-described databases, etc., of the system 100 illustrated in FIG. 1. This above-described data structure is not intended to limit the data that can be included in the historical data, but is merely provided as an example implementation of an embodiment of the present disclosure.

Referring to FIG. 19C, a data structure of campaign data is illustrated.

Specifically, campaign data as discussed above with reference to various figures can include any or all of the following: campaign name; campaign audience based on any or all of UPC, category, recency, etc.; campaign partner(s); campaign objective; product information (per product or group of products; maximum CPM (per product or group of products); impressions (per product or group of products); conversions (per product or group of products, for products that have been purchased for which advertisements have been delivered); conversion rate (per product or group of products, for products for which advertisements have been delivered); cost per advertisement delivered (per product or group of products); average CPM (per product or group of products); total spent on campaign (per product or group of products); units sold (with or without delivered advertisement associated therewith, per product or group of products); and additional campaign information. A campaign partner is, for example, a retailer (e.g., Safeway®) to which the campaign is directed.

Any or all of this information included in the campaign data can be accumulated on an ongoing basis as a campaign develops and is implemented. For example, the conversions, cost per advertisement delivered, average CPM, total spent, etc., will change over time based on the success of the campaign. Additionally, the user (e.g., the manufacturer) may change the maximum CPM, the campaign partners, etc., during the implementation of the campaign. This above-described campaign data is described in detail with reference to FIGS. 11-16 and redundant descriptions thereof are omitted. In an implementation, this above-described data can be stored in any of the above-described databases, etc., of the system 100 illustrated in FIG. 1. This above-described data structure is not intended to limit the data that can be included in the campaign data, but is merely provided as an example implementation of an embodiment of the present disclosure.

Referring to FIG. 19D, a data structure of bid data is illustrated.

Specifically, bid data as discussed above with reference to various figures can include any or all of the following: budget cap and timeframe (e.g., per week); start date; end date; maximum CPM; and additional bid information. This above-described bid data is described in detail with reference to FIGS. 11-16 and redundant descriptions thereof are omitted. In an implementation, this above-described data can be stored in any of the above-described databases, etc., of the system 100 illustrated in FIG. 1. This above-described data structure is not intended to limit the data that can be included in the bid data, but is merely provided as an example implementation of an embodiment of the present disclosure.

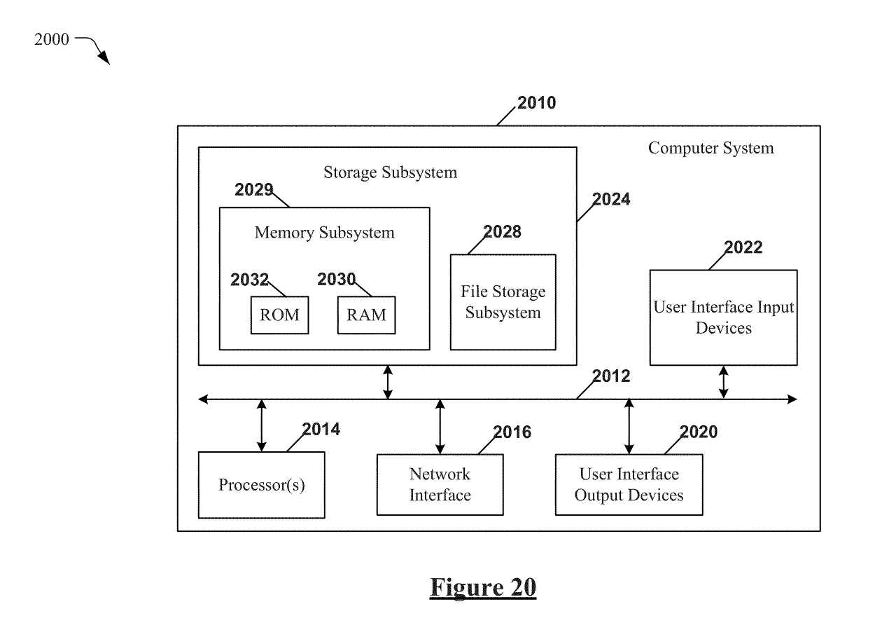

FIG. 20 is a block diagram of an example computer system, according an embodiment of the present disclosure.

Referring to FIG. 20, a block diagram 2000 representing an example computer system 2010 (e.g., laptop, desktop, tablet, smart phone, smart watch, etc.) is illustrated. This computer system 2010, or portions thereof, can be implemented as any or all of the components of the system 100 illustrated in FIG. 1, including, for example, the marketing computer 104, the server 130, the retail server 108, the consumer device 122, the campaign engine 102, the UPC library database 132, the user profile database 134, the marketplace management server 136, the bidding engine 138, the advertisement distribution engine 140, the media delivery server 144, the advertisement/UPC history database 146, the campaign data server/database 148, the consumer device 122, etc. Further, the computer system 2010, or portions thereof, may be implemented as a handheld smart device, such as a smartphone, tablet, etc. Additionally, the system 100 may not be limited to the use of a single computer system 2010, such that the system 100 may implement an unlimited number of computer systems 2010.

The computer system 2010 includes at least one processor 2014 that communicates with a number of peripheral devices via bus subsystem 2012. These peripheral devices can include a storage subsystem 2024 including, for example, a memory subsystem 2029 and a file storage subsystem 2028, user interface input devices 2022, user interface output devices 2020, and a network interface 2016.

The user interface input devices 2022 and the user interface output devices 2020 allow user interaction with the computer system 2010. The network interface 2016 provides an interface to outside networks, including an interface to corresponding interface devices in other computer systems.

The user interface input devices 2022 can include, for example, a keyboard, pointing devices such as a mouse, trackball, touchpad, or graphics tablet, a scanner, a touch screen incorporated into a display, audio input devices such as voice recognition systems and microphones, and other types of input devices. In general, use of the term “input device” is intended to include all possible types of devices and ways to input information into the computer system 2010.

The user interface output devices 2020 can include, for example, a display subsystem, a printer, a fax machine, and non-visual displays such as audio output devices. The display subsystem (not illustrated) can include a cathode ray tube (CRT), a flat-panel device such as a liquid crystal display (LCD), a projection device, and/or some other mechanism for creating a visible image. The display subsystem can also provide a non-visual display such as audio output devices. In general, use of the term “output device” is intended to include all possible types of devices and ways to output information from the computer system 2010 to the user or to another machine or computer system.

The storage subsystem 2024 stores programming and data constructs that provide the functionality of some or all of the modules and methods described herein. These software modules are generally executed by the processor(s) 2014 alone or in combination with other processors.

The memory subsystem 2029 of the storage subsystem 2024 can include a number of memories including a main random access memory (RAM) 2030 for storage of instructions and data during program execution and a read only memory (ROM) 2032 in which fixed instructions are stored.

The file storage subsystem 2028 can provide persistent storage for program and data files, and can include a hard disk drive, a floppy disk drive along with associated removable media, a CD-ROM drive, an optical drive, or removable media cartridges. The modules implementing the functionality of certain implementations can be stored by the file storage subsystem 2028 of the storage subsystem 2024, or in other machines accessible by the processor(s) 2014.

The bus subsystem 2012 provides a mechanism for letting the various components and subsystems of the computer system 2010 communicate with each other as intended. Although the bus subsystem 2012 is shown schematically as a single bus, alternative implementations of the bus subsystem 2012 according to an embodiment of the present disclosure can use multiple busses.

The computer system 2010 can be of varying types including a workstation, a server, a computing cluster, a blade server, a server farm, or any other data processing system or computing device. Due to the ever-changing nature of computers and networks, the description of the computer system 2010 illustrated in FIG. 20 is intended only as one example. Many other configurations of the computer system 2010 are possible having more or fewer components than the computer system 2010 illustrated in FIG. 20.

Other implementations of the present disclosure may include a non-transitory computer-readable recording medium having a program recorded thereon, the program causing a computer including at least one of a processor and a memory to perform/execute any of the methods, operations and/or functions described above. Yet another implementation may include a system including memory and one or more processors operable to execute instructions, stored in the memory, to perform any of the methods, operations and/or functions described above. While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

1. A computer-implemented method of providing one or more targeted advertisements to a consumer, the method including:
collecting shopping cart data from numerous point of sale (POS) terminals in physical stores, the shopping cart data identifying a consumer using a unique consumer identification and identifying one or more universal product codes (UPCs) scanned while the identified consumer is present at one of the POS terminals;
conducting an online UPC auction to collect bids, by UPC or a group of UPCs, for delivery of advertisements to the identified consumer triggered by scanning of a UPC or UPCs in the physical stores, in which winning bids, if any, are determined as of the time the identified consumer is present at the POS terminal, wherein:
a current winning bidder for a particular UPC is entitled to send their advertisement to the POS terminal for printing and/or send an electronic advertisement to the identified consumer; and
the online UPC auction accepts bids and withdrawal of bids from bidding participants using bidding terminals, and determines the current winning bidder from among the bidding participants on an ongoing basis by:
providing a bidding interface to the bidding terminals that identifies the UPCs that are available through the online UPC auction;
receiving from the bidding interface, bids on selected UPCs of the available UPCs;
tracking, for the selected UPCs, bid scores based at least in part on the bids on the selected UPCs; and
while the identified consumer remains present at the POS terminal, using at least the bid scores to determine a current best bid for a particular UPC and determining, among the one or more UPCs identified by the shopping cart data, which UPCs have winning bidders; and
on behalf of a winning bidder, fulfilling the winning bidder's bid by, at least one of, sending the advertisement to the POS terminal for printing and sending the electronic advertisement to the identified consumer.

2. The computer-implemented method of claim 1, wherein the receiving from the bidding interface further includes receiving contents of an advertisement.

3. The computer-implemented method of claim 1, wherein the received bids are for delivering the advertisement during a time frame starting from a certain start date and ending at a certain end date.

4. The computer-implemented method of claim 3, wherein the received bids are for delivering the advertisement to a specified number of consumers during the time frame.

5. The computer-implemented method of claim 1, further comprising:
setting, by the winning bidder, criteria according to which the advertisement must be sent to the identified consumer; and
sending the advertisement to the identified consumer only when the identified consumer satisfies the criteria set by the winning bidder.

6. The computer-implemented method of claim 5, wherein the criteria includes at least one of:
recent purchases of the identified consumer;
dollar amount of the recent purchases of the identified consumer; and
an ending date for which the advertisement can be delivered to the identified consumer.

7. The computer-implemented method of claim 1, wherein:
the electronic advertisement is sent to a mobile device application for use by identified consumer; and
the mobile device application includes an interface allowing the identified consumer to accept or reject received advertisements;
the rejected advertisements are deleted; and
the accepted advertisements are stored in a list.

8. The computer-implemented method of claim 1, wherein the electronic advertisement is sent to a mobile device application for use by the identified consumer on behalf of the winning bidder.

9. A non-transitory computer-readable recording medium having a program recorded thereon, the program for providing one or more targeted advertisements to a consumer, and the program causing a computer comprising at least one of a processor and a memory to execute the computer-implemented method of claim 1.

10. A computer-implemented method of providing one or more targeted advertisements to a consumer, the method including:
collecting one or more universal product codes (UPCs) scanned while a consumer is present at one point of sale (POS) terminal of numerous POS terminals in physical stores;
conducting an online UPC auction to collect bids, by UPC or a group of UPCs, for delivery of advertisements to the consumer triggered by scanning of a UPC or UPCs in the physical stores, in which winning bids, if any, are determined as of the time the consumer is present at the POS terminal, wherein:
a current winning bidder for a particular UPC is entitled to send their advertisement to the POS terminal for printing; and
the online UPC auction accepts bids and withdrawal of bids from bidding participants using bidding terminals, and determines the current winning bidder from among the bidding participants on an ongoing basis by:
providing a bidding interface to the bidding terminals that identifies the UPCs that are available through the online UPC auction;
receiving from the bidding interface, bids on selected UPCs of the available UPCs;
tracking, for the selected UPCs, bid scores based at least in part on the bids on the selected UPCs; and
while the consumer remains present at the POS terminal, using at least the bid scores to determine a current best bid for a particular UPC and determining, among the one or more collected UPCs, which UPCs have winning bidders; and
on behalf of a winning bidder, fulfilling the winning bidder's bid by sending the advertisement to the POS terminal for printing.

11. The computer-implemented method of claim 10, wherein the electronic advertisement is sent to a mobile device application for use by the identified consumer on behalf of the winning bidder.

12. A non-transitory computer-readable recording medium having a program recorded thereon, the program for providing one or more targeted advertisements to a consumer, and the program causing a computer comprising at least one of a processor and a memory to execute the computer-implemented method of claim 10.

13. A computer-implemented method of providing one or more targeted advertisements to a consumer, the method including:
accumulating, as historical data, shopping cart data from numerous point of sale (POS) terminals in physical stores, the shopping cart data identifying a consumer using a unique consumer identification and identifying one or more universal product codes (UPCs) scanned while the identified consumer is present at one of the POS terminals;
conducting an online UPC auction to collect bids, by UPC or a group of UPCs, for delivery of advertisements to the identified consumer triggered by identification of the consumer at the POS terminal, in combination with the historical data that identifies UPCs of goods purchased by the identified consumer in the physical stores, in which winning bids, if any, are determined as of the time the identified consumer is present at the POS terminal, wherein:
the online UPC auction is conducted using the one or more UPCs identified by the historical data collected in a historical period of at least one week and associated with the unique consumer identification of the identified consumer;
a current winning bidder for a particular UPC is entitled to send their advertisement to the POS terminal for printing, and/or send an electronic advertisement to the identified consumer; and
the online UPC auction accepts bids and withdrawal of bids from bidding participants using bidding terminals, and determines the current winning bidder from among the bidding participants on an ongoing basis by:
receiving from a bidding interface, bids on selected UPCs of UPCs that are available UPCs through the online UPC auction, the selected UPCs being included in the historical data;
tracking, for the selected UPCs, bid scores based at least in part on the bids on the selected UPCs; and
while the identified consumer remains present at the POS terminal, using at least the bid scores to determine a current best bid for a particular UPC and determining, among the one or more UPCs identified by the historical data, which UPCs have winning bidders; and
on behalf of a winning bidder, fulfilling the winning bidder's bid by, at least one of, sending the advertisement to the POS terminal for printing and sending the electronic advertisement to the identified consumer.

14. The computer-implemented method of claim 13, further comprising:
setting, by the winning bidder, criteria according to which the advertisement must be sent to the identified consumer; and
sending the advertisement to the identified consumer only when the identified consumer satisfies the criteria set by the winning bidder,
wherein the criteria includes at least one of:
recent purchases of the identified consumer;
dollar amount of the recent purchases of the identified consumer; and
an ending date for which the advertisement can be delivered to the identified consumer.

15. A non-transitory computer-readable recording medium having a program recorded thereon, the program for providing one or more targeted advertisements to a consumer, and the program causing a computer comprising at least one of a processor and a memory to execute the computer-implemented method of claim 13.

16. A computer-implemented method of providing one or more targeted advertisements to a consumer, the method including:
collecting shopping cart data from numerous point of sale (POS) terminals in physical stores, the shopping cart data identifying a consumer using a unique consumer identification and identifying one or more remnant universal product codes (UPCs) scanned while the identified consumer is present at one of the POS terminals;
conducting an online UPC auction to collect bids, by UPC or a group of UPCs, for delivery of advertisements to the identified consumer triggered by scanning of a remnant UPC or remnant UPCs in the physical stores, in which winning bids, if any, are determined as of the time the identified consumer is present at the POS terminal, wherein:
the remnant UPC or the remnant UPCs are a portion of available UPCs that have not been exclusively sold through a pre-auction channel;
a current winning bidder for a particular remnant UPC is entitled to send their advertisement to the POS terminal for printing, and/or send an electronic advertisement to the identified consumer; and
the online UPC auction accepts bids and withdrawal of bids from bidding participants using bidding terminals, and determines the current winning bidder from among the bidding participants on an ongoing basis by:
providing a bidding interface to the bidding terminals that identifies the remnant UPCs that are available through the online UPC auction;
receiving from the bidding interface, bids on selected remnant UPCs of the available remnant UPCs;
tracking, for the selected remnant UPCs, bid scores based at least in part on the bids on the selected remnant UPCs; and
while the identified consumer remains present at the POS terminal, using at least the bid scores to determine a current best bid for a particular remnant UPC and determining, among the one or more remnant UPCs identified by the shopping cart data, which remnant UPCs have winning bidders; and
on behalf of a winning bidder, fulfilling the winning bidder's bid by, at least one of, sending the advertisement to the POS terminal for printing and sending the electronic advertisement to the identified consumer.

17. The computer-implemented method of claim 16, wherein the electronic advertisement is sent to a mobile device application for use by the identified consumer on behalf of the winning bidder.

18. A non-transitory computer-readable recording medium having a program recorded thereon, the program for providing one or more targeted advertisements to a consumer, and the program causing a computer comprising at least one of a processor and a memory to execute the computer-implemented method of claim 16.

19. A system for providing one or more targeted advertisements to a consumer, the system comprising:
a bidding server including a processor and memory configured to:
receive shopping cart data collected from numerous point of sale (POS) terminals in physical stores, the shopping cart data identifying a consumer using a unique consumer identification and identifying one or more universal product codes (UPCs) scanned while the identified consumer is present at one of the POS terminals; and
conduct an online UPC auction to collect bids, by UPC or a group of UPCs, for delivery of advertisements to the identified consumer triggered by scanning of a UPC or UPCs in the physical stores, in which winning bids, if any, are determined as of the time the identified consumer is present at the POS terminal, wherein:
a current winning bidder for a particular UPC is entitled to, via a fulfillment server, send their advertisement to the POS terminal for printing and/or send an electronic advertisement to the identified consumer; and
the bidding server, by conducting the online UPC auction, accepts bids and withdrawal of bids from bidding participants using bidding terminals, and determines the current winning bidder from among the bidding participants on an ongoing basis by:
providing a bidding interface to the bidding terminals that identifies the UPCs that are available through the online UPC auction;
receiving from the bidding interface, bids on selected UPCs of the available UPCs;
tracking, for the selected UPCs, bid scores based at least in part on the bids on the selected UPCs; and
while the identified consumer remains present at the POS terminal, using at least the bid scores to determine a current best bid for a particular UPC and determining, among the one or more UPCs identified by the shopping cart data, which UPCs have winning bidders; and
the fulfillment server including a processor and a memory configured to, on behalf of a winning bidder determined by the bidding server, fulfilling the winning bidder's bid by, at least one of, sending the advertisement to the POS terminal for printing and sending the electronic advertisement to the identified consumer.

20. The system of claim 19, wherein the electronic advertisement is sent to a mobile device application for use by the identified consumer on behalf of the winning bidder.
